(19) United States
(12) Patent Application Publication
(10) Pub. No.: US 2005/0256766 A1
(43) Pub. Date: Nov. 17, 2005

(54) Method and system for targeted internet search engine

(76) Inventors: Johann S. Garcia, Kirkland, WA (US); Larry A. Greco, Bellevue, WA (US); Tony Thompson, McLean, VA (US); Steven Ng, Corona, CA (US)

Correspondence Address: OLYMPIC PATENT WORKS PLLC, P.O. BOX 4277, SEATTLE, WA, 98104, US

(21) Appl. No.: 10/513,288

(22) PCT Filed: May 30, 2003
(86) PCT No.: PCT/US03/17304

§ 371 Date: Jul. 14, 2005

Related U.S. Application Data
(60) Provisional application No. 60/384,666, filed on May 31, 2002.

(51) Int. Cl. G06F 17/60; G06F 7/00; G06F 17/30

(52) U.S. Cl. 705/14; 707/3

(57) ABSTRACT

A system and method for implementation of a pay-for-placement advertising model using a targeted search engine. The present invention provides a method and system for a geographic-targeted, pay-for-placement search engine which allows advertisers to direct their advertisements and Web site to geographic areas in a way which maximizes the return on their advertising expenditures. Global Positioning System (“GPS”) devices may be used to provide geographic location information to the search engine. Targeted advertising campaigns may be created and managed by advertisers using search engine tools. A search engine management system allows review and management of advertiser's account activity. A fraud detection system prevents advertisers using the system from incurring charges due to improper and fraudulent use of the search engine.

### CROSS-REFERENCE TO RELATED APPLICATION

This application claims priority of prior App. No. PCT/US03/17304, which claims benefit of Prov. App. No. 60/384,666 filed May 31, 2002.

### BACKGROUND OF THE INVENTION

The present invention relates generally to networked computer systems and in particular to computer systems for displaying information in response to Internet-based search requests.

The Internet is a global network of computers. There are more than 200 million computers linked in the Internet, and this number is increasing daily. These computers function as clients and/or servers. A broad class of clients can be defined as Web browsers hosted by devices such as personal computers to display information from the Internet. Servers can be defined as software programs running on computers that make information available to Web browsers on the internet. The network of clients and servers supplying information over the Internet is often called the World Wide Web (Web). Information stored within the Web is typically stored in formatted documents written in Hyper Text Mark-up Language (HTML). These HTML documents may also reference files containing audiovisual information such as images, sounds, animations, or videos to be displayed in the HTML document. There can also be links (hyperlinks) to other HTML documents on the Web. A group of HTML documents organized around some central theme and served from a single server is commonly termed a “Web site.” Each HTML document is stored at a specific “address” on the Internet. For example, below is the address to a document at the White House:
http://www.whitehouse.gov/WH/EOP/html/principals.html
   The address is formally known as the Uniform Resource Locator (URL) of the HTML document.

URLs are used by Web browsers to retrieve the HTML documents. The user can type the complete address of the HTML document they are looking for into a text field at the top of their Web browser and the Web browser will retrieve a HTML document from the address and generate a display based on the formatting instructions within the HTML document. The user can then select a hyperlink embedded in the display to instruct the Web browser to retrieve another document.

The ever-increasing number of Web sites comprising the Web has prompted the development of specialized Web sites containing databases of Web sites organized by searchable keywords. These specialized Web sites are known as “search engines.” A search engine can be thought of as a store directory for the Internet. Just as it is impractical to visit a large shopping mall and find a specific item by going from unknown store to unknown store, it may be impossible to find information on the Internet without a directory. Users go to these search engines and type in a word, phrase, or a question. The search engine generates a database query based on the word, phrase, or question and queries its database of Web sites and returns to the user a list of Web sites that contain the word, phrase, or possibly the answer to the question.

Search engine providers have utilized a pay-for-placement advertising structure to raise revenue. Since the average Internet user usually only looks at the first ten search results, advertisers may make agreements with the search engine provider to pay a certain amount per search request to have their listing located at the top or near the top of the search result listings. On some search engines, advertisers may bid a specified amount on particular search terms. Listings are presented for the particular search term according to which listing has the highest bid amount associated with that particular search term.

Present search engines provide advertisers with the option to add their Web site address to the database to be searched by a search engine. This option provides the advertiser with no ability to target particular consumer groups and no control over where in the search results their Web site address will appear. Some search engines have implemented a pay-for-placement model so that advertisers may bid on the location that their Web site address will be presented in a search term. Under this model, the advertiser may bid a particular amount they are willing to pay the search engine provider each time their Web site address is selected. The Web site address are presented to the user in descending bid amount order with the listing with the greatest bid amount appearing first. While present pay-for-placement model give advertisers some control over where their Web site address will appear in a search result, advertiser still have no ability to direct their Web site to a particular group of consumers. Advertisers, therefore, pay to have their listings selected by users who have no real interest in the advertisers listing. As a result, advertisers cannot achieve the maximum benefit from their expenditures on advertising and their bid amounts are wasted on displaying their listings to users who do not purchase the advertiser's products or services.

Therefore, it would be advantageous to develop a targeted search engine capable of supporting a pay-for-placement advertising model that allows advertisers to limit inclusion of their advertisement in a search result in a way that maximizes advertising effectiveness.

### SUMMARY OF THE INVENTION

The present invention provides a method and system to solve the above-discussed problems associated with present Internet search engines. Specifically, the present invention provides a method and system for a targeted, pay-for-performance search engine which allows advertisers to target their advertisements and Web site to in a way which maximizes the return on their advertising expenditures.

An embodiment in accordance with the present invention is directed to an Internet based search engine which searches both on the World Wide Web and off the World Wide Web to match merchants with users. More specifically, the Internet based search engine which matches users with merchants who pay for performance. The search engine also matches users with merchants who are located near each other. The search engine may incorporate global positioning system (“GPS”) satellite technology or other geographic identifiers to identify the location of the user. The search engine allows the merchant to target users who posses a geographic location or demographic trait as specified by the advertiser. The search engine provides an interface to allow the advertisers to select the type of advertisement, select format of display, the platform for the advertisement to be displayed on, and select a web page display or telephone directory-type display for the advertisement.

In one aspect of the invention, a method for generating a targeted search result is disclosed. The method includes receiving a search request from a user over a communications network, the search request including a search term and a limiting parameter, generating a search listing using the search term and the limiting parameter, sorting the search listing using a performance criterium, generating a search result using the sorted search listing, and transmitting the search result to the user.

In another aspect of the invention, the method further includes sorting the search listing using a second performance criterium, wherein the second performance criterium is an advertiser importance value.

In another aspect of the invention, the method further includes providing a database having a plurality of advertisements, wherein each of the plurality of advertisements includes a preferential placement indication, and wherein sorting the search listing includes placing the one or more of the plurality of advertisements in a preferred position in the search result.

In another aspect of the invention, the method further includes providing a database having a plurality of advertisements, wherein each of the plurality of advertisements includes an advertisement search parameter and a geographic targeting parameter, and the step of generating a search listing further includes generating a relevance measure for each of the advertisements by comparing the search term to each of the advertisement search parameters, generating a geographic measure for each of the advertisements by comparing the limiting parameter to each of the geographic targeting parameters, and retrieving advertisements from the database using each of the relevance measures and each of the geographic measures.

In another aspect of the invention, wherein the search result includes one or more selectable listings, the method further includes receiving a listing selection from the user, updating a selection record using the listing selection, and charging an advertiser account using the selection record.

In another aspect of the invention, the method further includes providing a database having a plurality of advertisements, wherein the plurality of advertisements are stored in the database in a table, the table including a network location field, and generating the search result includes selecting the network location field from the table.

In another aspect of the invention, a method for generating a targeted search result is disclosed. The method includes receiving a search request from a user over a communications network, the search request including a search term, a demographic parameter, and a limiting parameter, generating a search listing using the search term, the limiting parameter, and the demographic parameter, sorting the search listing using a performance criterium, and transmitting a search result to the user, the search result generated using the sorted search listing.

In another aspect of the invention, an apparatus for generating a targeted search result is disclosed. The apparatus includes means for receiving a search request from a user over a communications network, the search request including a search term and a limiting parameter, means for generating a search listing using the search term and the limiting parameter, means for sorting the search listing using a performance criterium, means for generating a search result using the sorted search listing, and means for transmitting the search result to the user, the search result further having one or more selectable listings.

### BRIEF DESCRIPTION OF THE DRAWINGS

These and other features, aspects, and advantages of the present invention will become better understood by referring to the following description, the appended claims, and accompanying drawings where:

FIG. 1A is a deployment diagram of Web browsers and a Web server in a targeted search engine in accordance with an exemplary embodiment of the present invention;

FIG. 1B is a block diagram of a targeted search engine prcoess in accordance with an exemplary embodiment of the present invention;

FIG. 1C is a diagram of the operation of the targeted search engine in accordance with an exemplary embodiment of the present invention;

FIG. 1D is a data flow diagram depicting use of a search term and a limiting parameter to generate a search result list in accordance with an exemplary embodiment of the present invention;

FIG. 1E is a process flow diagram depicting a search result list generation process in accordance with an exemplary embodiment of the present invention;

FIG. 1F is a process flow diagram depicting a search term mapping process in accordance with an exemplary embodiment of the present invention;

FIG. 1G is a process flow diagram of an example of a search term mapping process in accordance with the process of FIG. 1F;

FIG. 1H is a process flow diagram of a limiting parameter expansion process in accordance with an exemplary embodiment of the present invention;

FIG. 1I is a process flow diagram of an example of a limiting parameter expansion process in accordance with FIG. 1H;

FIG. 1J is a flow diagram of the operation of the targeted search engine in accordance with an exemplary embodiment of the present invention;

FIG. 2 is a hardware architecture diagram for a general purpose computer capable of hosting a search engine in accordance with an exemplary embodiment of the present invention;

FIG. 3 is a sequence diagram of a targeted search result creation process in accordance with an exemplary embodiment of the present invention;

FIG. 4 is a sequence diagram of the process of creating and providing targeted search results in connection with GPS enabled devices in accordance with an exemplary embodiment of the present invention;

FIG. 5 is a process flow diagram of the steps a user takes to perform a targeted search in accordance with an exemplary embodiment of the present invention;

FIG. 6 is a Web page showing a user search form in accordance with an exemplary embodiment of the present invention;

FIG. 7 is a Web page showing a search result in accordance with an exemplary embodiment of the present invention;

FIG. 8 is a process flow diagram of the steps an advertiser performs to create an account with the targeting search engine in accordance with an exemplary embodiment of the present invention;

FIG. 9 is a Web page showing a search directory selection form in accordance with an exemplary embodiment of the present invention;

FIG. 10 is a Web page showing a company information entry form in accordance with an exemplary embodiment of the present invention;

FIG. 11 is a Web page showing a default search information entry form in accordance with an exemplary embodiment of the present invention;

FIG. 12 is a Web page showing a default search term creation form in accordance with an exemplary embodiment of the present invention;

FIG. 13 is a Web page showing a search term selection form in accordance with an exemplary embodiment of the present invention;

FIG. 14 is a Web page showing a search term individualization and bid specification form in accordance with an exemplary embodiment of the present invention;

FIG. 15 is process flow diagram of the steps an advertiser performs to create a targeted advertising campaign in accordance with an exemplary embodiment of the present invention;

FIG. 16 is a Web page showing a campaign setting selection form in accordance with an exemplary embodiment of the present invention;

FIG. 17 is a Web page showing a campaign information entry form in accordance with an exemplary embodiment of the present invention;

FIG. 18 is a Web page showing a geographic targeting selection form in accordance with an exemplary embodiment of the present invention;

FIG. 19 is a Web page showing a campaign term selection form in accordance with an exemplary embodiment of the present invention;

FIG. 20 is a Web page showing a campaign term individualization and bid specification form in accordance with an exemplary embodiment of the present invention;

FIG. 21 is a Web page showing a campaign confirmation form in accordance with an exemplary embodiment of the present invention;

FIG. 22 is a Web page showing an advertiser management page in accordance with an exemplary embodiment of the present invention;

FIG. 23 is a Web page showing a advertiser account management page in accordance with an exemplary embodiment of the present invention;

FIG. 24 is a process flow diagram of the steps a search engine server administrator performs to review advertiser sign ups and campaign creations in accordance with an exemplary embodiment of the present invention;

FIG. 25 is a screen shot of a search engine management order system in accordance with an exemplary embodiment of the present invention;

FIG. 26 is a screen shot of a search engine advertisement review system in accordance with an exemplary embodiment of the present invention;

FIG. 27 is a screen shot of a search engine user interface for a wireless device in accordance with an exemplary embodiment of the present invention; and

FIG. 28 is a process flow diagram of a search engine log creation and fraud prevention system in accordance with an exemplary embodiment of the present invention.

### DETAILED DESCRIPTION

Embodiments of the invention are described below. It will be apparent to one of skill in the art that the various disclosed embodiments may be combined, in whole or in part, using any possible combination. The steps described in the various disclosed embodiments may be used combined in any order and combination.

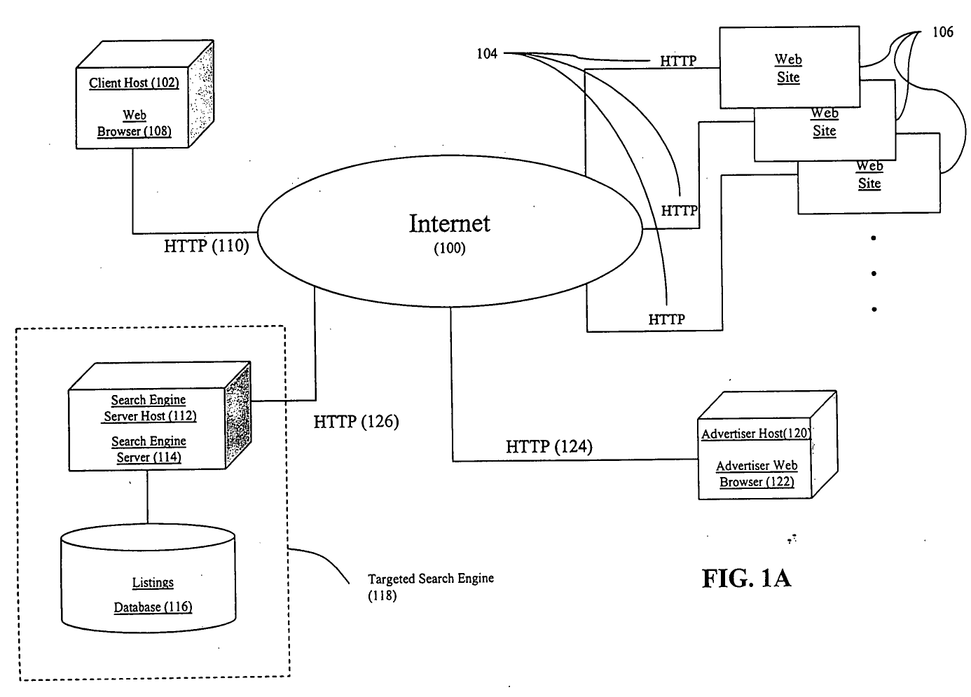

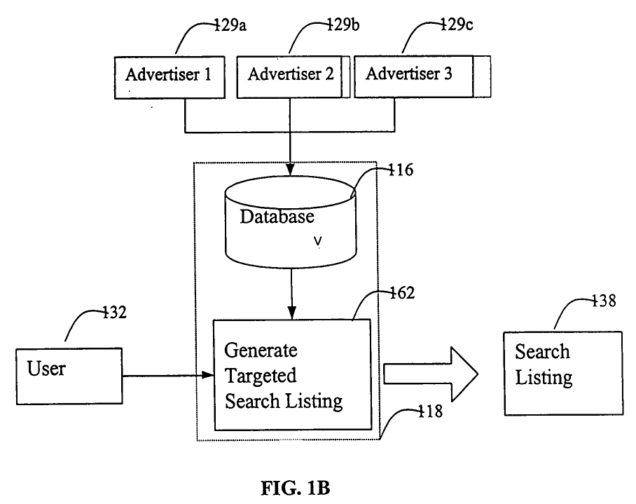

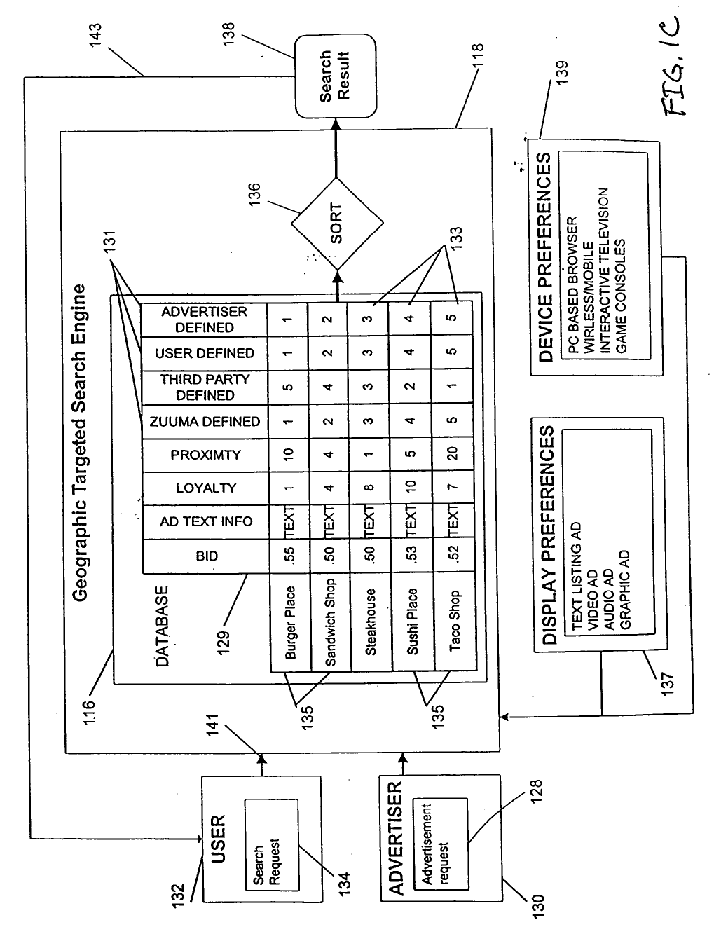

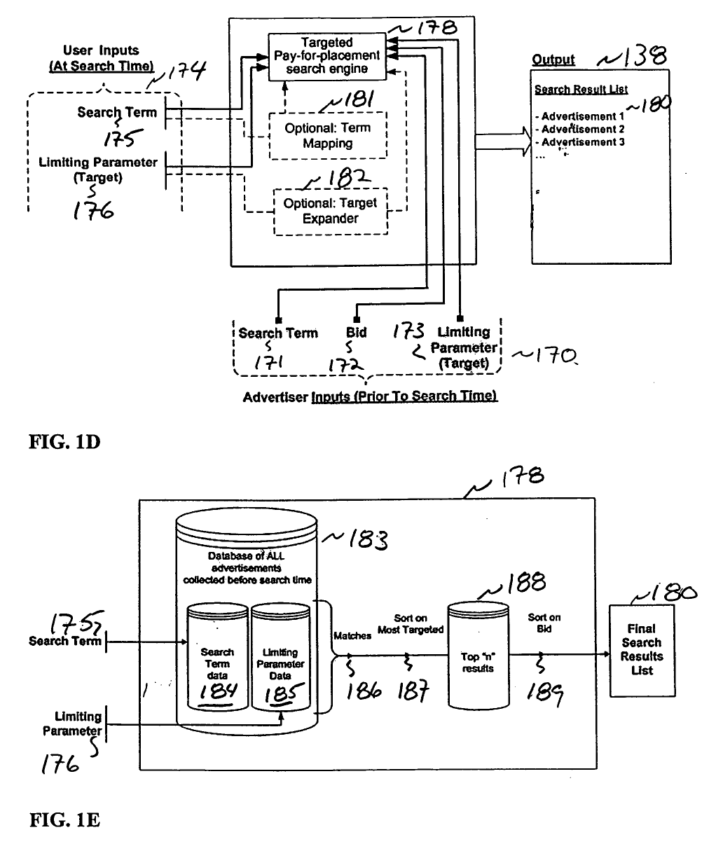

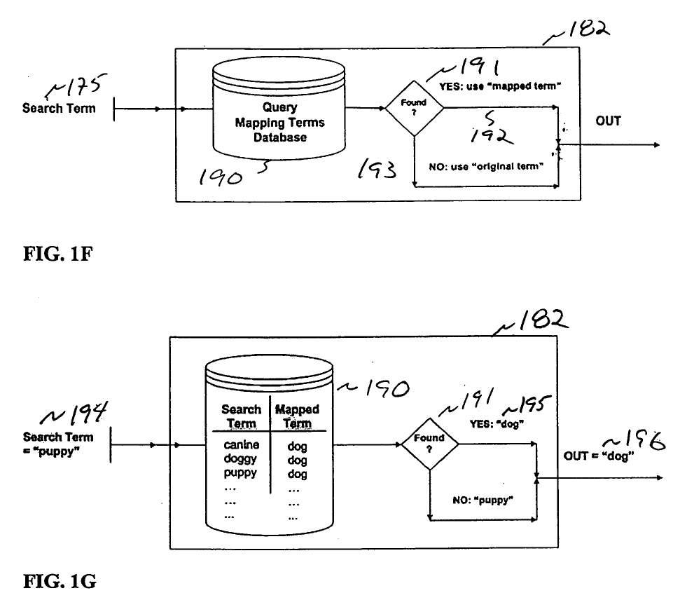

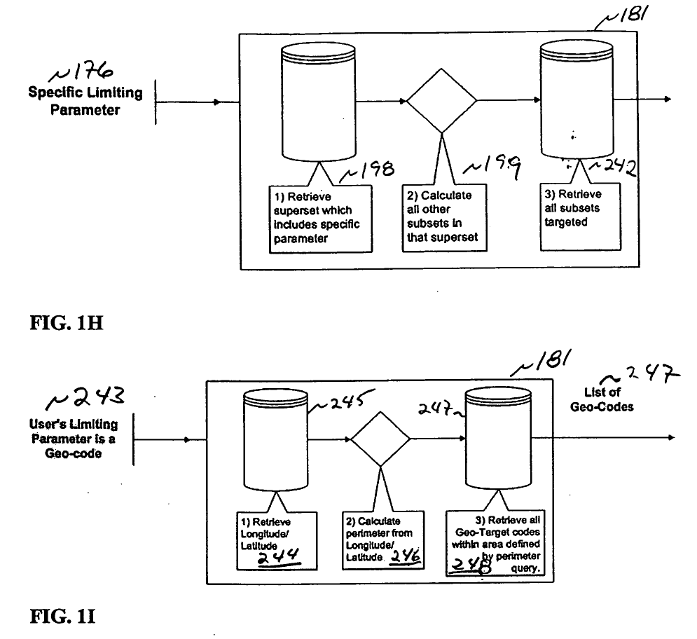

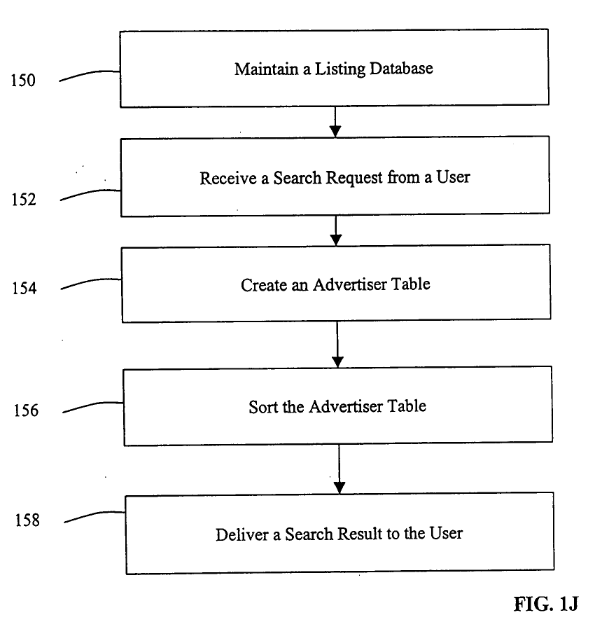

FIG. 1A is a deployment diagram of Web servers and a Web browser coupled via a communications network in accordance with an embodiment of the present invention. A client host 102 hosts a Web browser 108, such as Internet Explorer or Netscape Navigator, coupled to the Internet 100 or any communications network, over a Web browser communications link 110. The Web browser communications link 110 is implemented using the Hyper Text Transfer Protocol (HTTP) on top of the Transmission Control Protocol/Internet Protocol (TCP/IP) suite of communications protocols. A plurality of Web sites 106 are also coupled to the Internet via a plurality of HTTP based Web site communications links 104. The Web sites supply HTML documents at the request of the Web browser and the Web browser displays the HTML documents.

A search engine server host 112 is provided which hosts a search engine server 114. The search engine server communicates to other objects on the Internet a using search engine server communications link 126. The search engine server responds to search requests from the Web browser with each search request including at least one search term and at least one limiting parameter, such as a geographic identifier. Geographic identifiers may be postal zip codes, city and state names, global positioning system coordinates, longitude and latitude coordinates, area codes, IP address, or any other similar identifier as specified by a user, or by a computer (such as a cookie), or by an operator of the present invention. The search engine server creates results documents by retrieving information stored in a listings database 116 coupled to the search engine server. The search engine server performs retrieve, sort, and join operations on listings stored in the listing database to generate search results in response to the search requests. A targeted search engine 118 includes the combination of the search engine server 114 and the listings database 145.

Advertiser host 120 hosts an advertiser Web browser 122, which communicates to other objects on the Internet using an HTTP based advertiser Web browser communication link 124. The advertiser Web browser is used by the advertiser to communicate with the search engine server 114 in order to access the search engine 118, create an advertiser account, create targeted advertising campaigns, and manage the advertiser account. An advertising campaign may include one or more advertisements.

FIG. 1B is a block diagram of a targeted search engine process in accordance with an exemplary embodiment of the present invention. Advertisers, such as advertisers 129a, 129b, and 129c, provide inputs including a search term, a bid amount, a limiting parameter or target assigned by an advertiser, and advertiser information such as such as a URL, account id, etc. These inputs are stored in a database 116 included in a targeted search engine 118. When accessing the search engine, a user 132 inputs a search term and a limiting parameter. The search engine uses the search term, the limiting parameter, and a performance criterium to generate 162 a search listing 138 including the advertiser information supplied by the advertisers.

Through the use of search terms, limiting parameters, and performance criteria, a targeted search engine satisfies the needs of three different concerned parties simultaneously. Search terms are used by the targeted search engine to allow users to find the goods or services that they are looking for, limiting parameters are used by the targeted search engine to allow advertisers to identify users that the advertiser wants to send a targeted advertisement, and performance criteria are used by the targeted search engine to allow a search engine operator to control, and thus profit, from the advertisers' and users' use of the targeted search engine.

FIG. 1C is a diagram of the operation of the targeted search engine in accordance with an embodiment of the present invention. In slightly more detail than FIG. 1B, the search engine 118 receives an advertisement request 128 from the advertiser 130. The advertisement request 128 includes an advertisement campaign. The advertisement request 128 is stored on the database 116. While one advertiser 130 is illustrated in FIG. 1B, any number of advertisement requests are received by the search engine from any number of advertisers, and the search engine 118 maintains the database 116, adding advertisement requests 128 to the database when they are received from the advertiser 130. An advertisement request 128 includes one or more advertisement search terms, one or more geographic targeting parameters, a bidding criterium, and a network location of the advertisement. In one embodiment, the advertisement request further includes an advertisement, a title for the advertiser, a description for the advertiser, one or more demographic targeting parameters, display format preferences, and display platform preferences, and other performance criteria which may be used in sorting of the search result. In another embodiment, the advertising campaign and network location of the advertiser is updated in response to an update request, either manually or automatically. Each advertiser has an advertising account and is assigned an identification number. In one embodiment, the search engine includes multiple advertisement requests and multiple advertising campaigns for each of the advertisers. Each advertisement campaign includes an identification number for tracking and processing of the advertisement campaigns. A table 129 includes categories 131 having ranking or performance criteria 133 for each of the advertisers 135 in the table 129. Display preferences 137 and device preferences 139 are transmitted to the search engine 118.

In another embodiment, the display format preferences 137 are received from the user, the advertiser, determined by the system administrator, or received from a third party. For example, the advertiser specifies that the advertisement be displayed using one or more of text, graphics, animation, audio, video, artistic presentations, multimedia presentations, a logo, such as a company logo, formatted text, such as bold print, italics, color, or any other typographical distinction, and information commonly found on a business card such as contact name, advertiser address, telephone number, Website, and email address. In another embodiment, the format of the advertisement is a Website of the advertiser.

In another embodiment, the search result and advertisement are formatted for display on a personal computer, by a mobile device that is Internet enabled, on a radio, in an automobile, on a game console, by a personal data assistant (“PDA”), on a television, or other interactive device. The display device format preferences 139 may be received from the user or the advertiser, or determined by the system administrator, or received from any other party.

The user 132 transmits the search request 134 to the search engine 118 as illustrated by transmission path 141. The search request 134 includes one or more search terms and one or more search scope parameters identifying the geographic location of the user. In one embodiment, the search request 134 further includes, for example, a second search scope parameter identifying the demographic traits of the user. Based on the search request 134, the search engine 118 generates a search listing using data from the database 116. The search engine 118 performs a sort operation 136 on the search listing using the search scope parameters and ranking parameters to generate a search result 138. The search result is sent to the user 132 over the communications network, illustrated by communications path 143.

FIG. 1D is a data flow diagram depicting use of a search term and a limiting parameter to generate a search result list in accordance with an exemplary embodiment of the present invention. A targeted search engine receives advertiser inputs 170 from an advertiser. The advertiser inputs include a search term 171, a bid amount 172, and a limiting parameter or target 173. The search term is a search term that the advertiser believes a user will use when looking for the advertiser's products or services. The bid amount 172 is the amount of compensation that the advertiser is willing to spend to be featured prominently in a search result listing. The limiting parameter is a parameter used to define a characteristic associated with a user that the advertiser believes identifies a user that the advertiser wants to send a targeted advertisement to.

When a user accesses the targeted search engine, the user provides a set of user inputs 174 including a search term and a limiting parameter. The search term is used by the user to describe the type of products or services that the user is looking for. The limiting parameter is a characteristic associated with the user that may be used to differentiate the user from other types of users. Exemplary limiting parameters include a demographic indicator such as the users age or socioeconomic standing or geographic indicator such as the users physical location. The targeted search engine then generates 178 a search result listing 138 having a sorted listing of advertisements using the user inputs and the advertiser inputs. In addition, the targeted search engine may map 181 the search term to another search term or may expand 182 the limiting parameter.

FIG. 1E is a process flow diagram depicting a search result list generation process in accordance with an exemplary embodiment of the present invention. A search result list generation process 178 operates by receiving a search term 175 and a limiting parameter 176 from the user and matching 186 them to search terms 184 and limiting parameter data 185 associated with advertisements in an advertisement database 183. The matching results are sorted 187 to identify the advertisements 188 that most closely match the search term and limiting parameter. The advertisements are sorted 189 using a bid amount that the advertisers whose advertisements have been identified are willing to spend in order to be displayed prominently in the final search results list 180.

FIG. 1F is a process flow diagram depicting a search term mapping process in accordance with an exemplary embodiment of the present invention. The targeted search engine may use a search term mapping process 181 to map or translate incoming search terms into search terms used by the advertisers. The targeted search engine receives a search term 175 and uses a query mapping table stored in a query mapping terms database 190 to generate a mapped search term. If the input search term is found 191 in the query mapping terms database, the mapped term 192 is used for matching to the search terms provided by the advertisers. If the input search term is not found in the query mapping terms database, the input search term is used 193 for matching purposes.

FIG. 1G is a process flow diagram of an example of a search term mapping process in accordance with the process of FIG. 1F. In this example, the search term 193 input into the search term mapping process 181 is “puppy”. Stored in the query mapping terms database 190 is a table mapping search terms to mapped terms. In this case, the table maps a plurality of search terms for dogs, including the search term “puppy”, to the mapped term “dog”. In this example, since the search term “puppy” is found 191 in the table, “puppy” is mapped to the mapped term “dog” 195 which is provided to a matching process used by the targeted search engine.

FIG. 1H is a process flow diagram of a limiting parameter expansion process in accordance with an exemplary embodiment of the present invention. In a similar manner to search term mapping, limiting parameters may be expanded using a limiting parameter expansion process 182 to provide matches between advertisers' limiting parameters and a user's limiting parameter. A specific limiting parameter 176 is received by the targeted search engine. The targeted search engine retrieves 198 a superset that includes the specific limiting parameter. The targeted search engine then calculates 199 all other subsets in the superset and then retrieves 242 the subsets so identified. In this way, limiting parameters that may be obtained from user inputs may be transformed into limiting parameters that are used to specify the type of user the advertiser wants to reach.

FIG. 1I is a process flow diagram of an example of a limiting parameter expansion process in accordance with FIG. 1H. In the example, the user's limiting parameter 243 input into the limiting parameter expansion process 182 is a geographic code such as a street address or zip code. The targeted search engine uses the geographic code to retrieve 244 a longitude and latitude associated with the street address or zip code in a geographic code database. The targeted search engine calculates 246 a perimeter around the longitude and latitude describing an area associated with the geographic code. The targeted search engine then uses the area to retrieve 248 all geographic codes in the area defined by the perimeter query. The retrieved geographic codes 247 are then used for matching to advertisers' limiting parameters.

FIG. 1J is a flow diagram of the operation of the targeted search engine in accordance with an embodiment of the present invention. The flow diagram generally depicts the steps of generating and delivering a search result list to the user in accordance with one embodiment of the present invention. The steps may be used in any order and combination. It will be apparent to one of skill in the art that the various disclosed embodiments may be combined, in whole or in part, in any possible combination.

In step 150, the targeted search engine maintains a database including advertising campaigns for any number of advertisers. Advertising campaigns are generated using the advertisement request received from the advertiser. Each advertising campaign entry or record in the database includes one or more of the following fields in any desired combination: an advertisement; a title for an advertiser; a description for an advertiser; one or more advertisement search terms, or other indication of search preference; one or more geographic targeting parameters; one or more demographic targeting parameters; a bidding criterium which may be a bid of money, points, or any other value attributed to a particular advertising campaign; and a network location of the advertisement. The network location of a particular advertiser's advertisement may be on either the user's computer or on a third party computer. The network location is one means by which the user may retrieve the advertiser's advertisement.

The advertising campaigns of each advertiser may be organized into a directory structure such that each of the search listing or search listings of one or more advertisers is organized into one or more categories, each such category may be organized into one or more subcategories, which may be further organized into additional subcategories. The directory structure is navigable by a user and may include any number of subcategory levels. In one embodiment, each selection of a category or subcategory generates a search request and search result.

In step 152, the targeted search engine receives the search request from the user, third party, or a third party computer. The search request includes one or more search terms and one or more search scope parameters identifying the geographic location of the user. In one embodiment, the search request includes additional search scope parameters that provide additional information about the user, for example, information identifying or approximating the demographic traits of such user.

In another embodiment, the search request includes, for example, one or more of the following as the identification of demographic traits of the user: a socioeconomic class identification, an income or income range identification, an ethnicity, race, or national origin identification, an age or age range identification, a community type identification, such as urban, suburban, or rural, and any other classification that can be used to identify demographic traits. In another embodiment, demographic traits are approximated or predicted based on the geographic location of the user using studies and other available data on the demographic makeup of a particular geographic area, such as, for example, census data. The search terms and search scope parameters include one or more keywords, numbers, symbols, or any other indication of the subject matter that the user is interested in. The search scope parameter and the targeting parameter used in the search engine includes, for example, any of the following: identification of a world-wide geographic location, a specific country, a zip code, a city, a state, a county, a political subdivision of the U.S. or any other country, a commercial subdivision, such as a region of a Multiple Listing Service (“MLS”) identification, government subdivision, such as a distinct region defined in the U.S. Census data, a full telephone number, a telephone number prefix, an area code, any other component part of a telephone number, latitude and longitude coordinates, a data stream from a global positioning system (“GPS”) satellite receiver, an IP address, and any other data that can be used to identify geographic or demographic traits.

In step 154, the targeted search engine creates a table having an entry or record for each advertiser. In one embodiment, each entry or record in the table includes the following categories or fields in any desired combination: a measure of the geographic relationship between the user and a particular advertiser, such a measure may be determined by using the search scope parameter identifying the location of the user and the particular advertiser's geographic targeting parameter specifying the desired location of targeted users; a measure of the degree to which the advertiser's demographic targeting parameter matches the demographic search scope parameters of the user, as approximated or identified in the user search request; a measure of advertiser loyalty; a measure of the relevancy of the user search request to an advertiser's advertisement; and a display field, that may include any combination of the particular advertiser's advertisement, the title, the description, the bidding criterium, and the network location of the particular advertiser's advertisement. In one embodiment, each category is associated with a column of the table. In one embodiment, the display field is used to form the search result that is displayed to the user. In another embodiment, the table includes any other desired measures or values, such as relevancy identifiers for targeting parameters and search scope parameters that may be used to influence, augment, or determine placement of a particular advertisement within the search result. The measures and values in the table may be determined by the administrator of the search engine, an advertiser, a value assigning algorithm or another third party using any conventional methods. For example, with respect to geographic location, the measure may be given greater value for a particular advertiser whose geographic targeting parameter is closer in proximity to the user's geographic search parameter.

In step 156, the targeted search engine sorts the entries or records in the table using one or more categories. In another embodiment, the search engine sorts according to a first category, and if any entries are tied in the sorting, the search engine sorts the tied entries according to a second category. Any desired number of categories is used to sort the table. Sorting may also be performed using any number of categories in a weighted equation, such that certain categories are given greater consideration in determining the sorting order.

In step 158, the targeted search engine delivers the search result to the user. In one embodiment, the column of the table having the display category is extracted from the sorted table such that the entries in the column remains in sorted order. In another embodiment, the display column is used to create the search result that is transmitted to the user over the communications network. In one embodiment, the search result takes the form of a list on the display screen. The user selects one of the advertisers or advertisements from the search result. The search engine records the user selection of a particular advertisement or listing from the search result to maintain of accurate records of which advertisement or listing was selected by the user. The records are used to charge each of the advertisers according to any desired method of billing. In another embodiment, the search engine performs operations in response to the user request in substantially real time.

In another embodiment, the search engine sorts the search result according to a measure or value indicating a preferential placement in the search result. Each of the advertisers pay to have the preferential placement of their advertisement. For example, preferential placement includes any of the following: guaranteed placement at a position relative to other advertisers or advertisements, guaranteed inclusion with the search result, guaranteed placement at a position, relative to other advertisers or advertisements, having minimum position, i.e. placement no lower than a specified position, guaranteed placement at a position, relative to other advertisers or advertisements, having a maximum position, i.e. no higher than a specified position, guaranteed placement within a range of positions relative to other advertisers or advertisements, guaranteed placement as the only advertiser or advertisement the search result, and any other type of preferential treatment. The measure may be determined by the system administrator, based on the amount of revenue generated by the advertiser, or the advertiser's relationship with the administrator of the search engine. In another embodiment, a preferential placement may be sold to an advertiser for a predetermined amount. For example, each of the first, second, and third locations in a listing may be associated with a predetermined amount, or placement with the first five listings or first ten listings may be associated with a predetermined amount.

In another embodiment, the advertiser has access to view the top bid amount associated with a particular search term, a particular geographic location, or a demographic identification. This feature permits the advertiser to identify the bid amount required to achieve the highest bid for a particular term, geographic location, demographic identification, or other category. The advertiser may also have access to the lowest bid, the number of bids, and any other desired bid information. In another embodiment, the advertiser is notified when another advertiser has out-bid, or bid a higher amount on a particular search term, geographic location, demographic identification, or other category.

In yet another embodiment, search engine input is provided using voice recognition technology. For example, the user verbally provides the search term and other desired input by speaking into the device or computer.

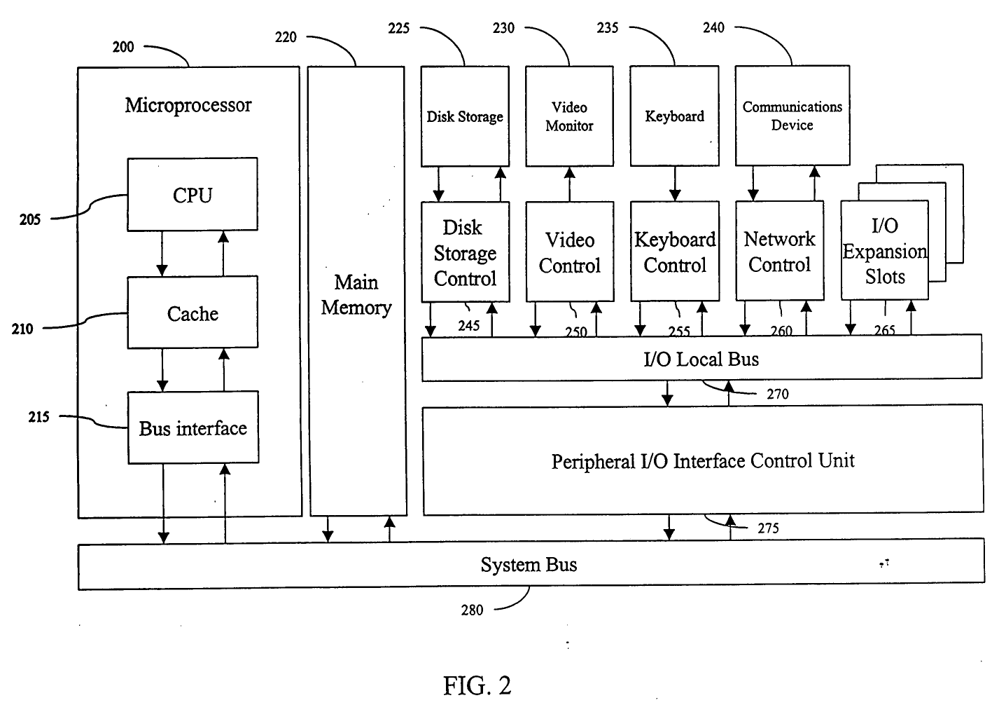

FIG. 2 is a hardware architecture diagram for a general purpose computer capable of hosting a search engine in accordance with an embodiment of the present invention. A microprocessor 200, including of a Central Processing Unit (CPU) 205, memory cache 210, and bus interface 215, is coupled via system bus 280 to main memory 220 and I/O control unit 275. The I/O interface control unit is coupled via I/O local bus 270 to disk storage controller 245, video controller 250, keyboard controller 255, network controller 260, and Input Output (I/O) expansion slots 265. The disk storage controller 245 is coupled to disk storage device 225. The video controller 250 is coupled to video monitor 230. The keyboard controller 255 is coupled to keyboard 235. The network controller 260 is coupled to a communications device 240.

Computer program instructions implementing the targeted search engine 118 software components are stored on the disk storage device 225 until the microprocessor 200 retrieves the computer program instructions and stores them in the main memory 220. The microprocessor 200 then executes the computer program instructions stored in the main memory 220 to implement the search engine software components. The disk storage device 225 is used to as permanent data storage for the listings database 116. The search engine server host 112 is coupled to Internet 100 via the communications device 240.

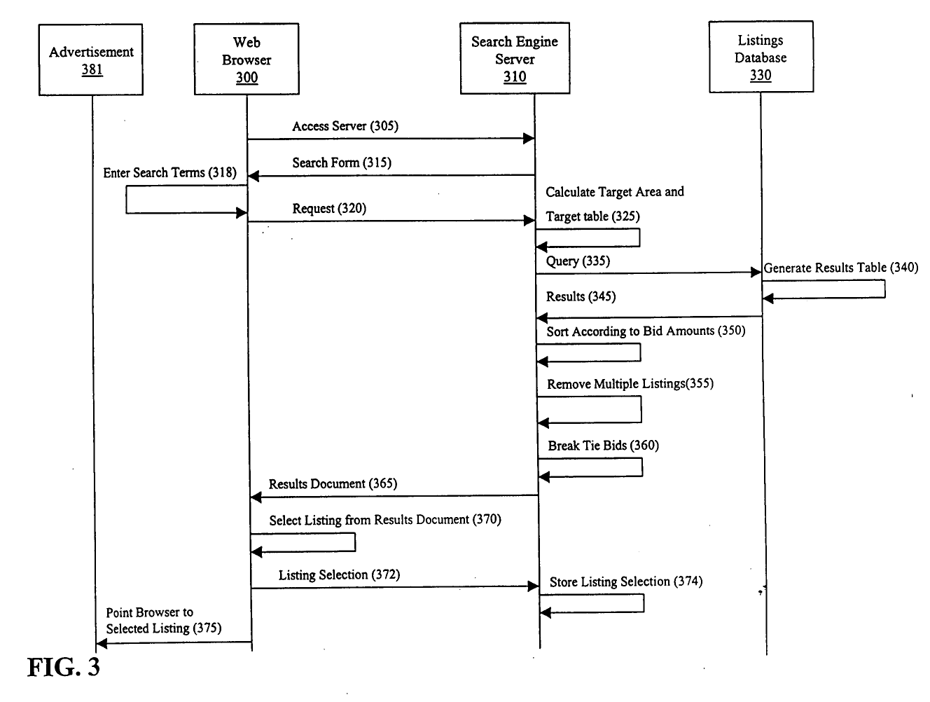

FIG. 3 is a sequence diagram of a targeted search result creation process in accordance with an embodiment of the present invention. A user first accesses the search engine server 305 by pointing a Web browser 300 to a search engine Web site. The search engine server sends a search form 315 to the Web browser for the user to enter desired search terms and any desired search scope parameter or geographic identifier. The user enters 318 the search terms and search scope parameters. The Web browser sends 320 the search request to the search engine server 310 in response to the search request. The search engine server then extracts the search terms and geographic identifier from the search request and creates a target table of all geographic locations within a predetermined proximity of the entered geographic identifier 325. The proximity may be expanded and decreased in order to control the number listings returned to the search engine server in response to a database query. A listings database 330 is then queried with the target table and the search terms 335, and a results table is generated having all listings that satisfy the database query 340. The search engine server may query the database using any desired number of fields, using a database query language or other information retrieval method. The listings database sends results table to the server 345. The results table is sorted according to predetermined sorting specifications 350. In one embodiment of the invention, the listings are sorted according to the bid amount with the higher bids ranked higher in the listing order. If desired, the results table may be operated on to remove multiple listings by the same advertiser 355. For example, one advertiser may have multiple listings in the results table, each listing targeting a different geographic location. To avoid charging the advertiser twice, the server will only display one listing to the user. For example, the server may display the listing that is geographically closer to the user. In another embodiment of a search engine in accordance with an embodiment of the present invention, the server may display the listing that is associated with a higher bid amount. Any desired criteria may be used to remove multiple listings by the same advertiser. Any number of sorting methods may be applied to the results table.

When more than one advertiser satisfying the query bids identical amounts on the search term, a sorting algorithm may be used to order listings with the same bid amounts 360. For example, the listing that was created first in time is presented first in the search results. Alternatively, advertisers may be classified with a particular ranking, for example, gold, silver, and bronze advertisers, and the advertiser with the higher ranking may have their listing presented first in the search results. Rankings may be established by gross revenue provided by the advertiser, amount of revenue in the advertiser's deposit account, or any other ranking criteria.

After any desired operations are performed on the results table, a result document is transmitted from the search engine server to the Web browser 365. The user selects a listing from the results document 370. The listing selection is transmitted to the search engine server 372. The search engine server stores the listing selection 374 by, for example, updating a selection record using the listing selection. The record may be maintained on the search engine server such that advertiser accounts may be charged for placement of the particular advertiser's advertisements. The Web browser 300 is directed to a Web site 380 associated with the selected listing 375.

In one embodiment, the targeted search engine 118 incorporates a pay-for-placement advertising model to create an improved method and system for advertisers to target their potential customers and maximize returns from advertising expenditures. Upon creating an account with the search engine, the advertiser may create default listing information. Under the default listing information, default search terms, default listing descriptions, and default targeting criteria may be specified. When the user performs a search using the targeted search engine, those advertisers' listings will be provided in a search result document to the user if the user's search terms and geographic identifier correspond to those identified by the advertiser. The correspondence, or matching, of the advertiser's geographic parameter and search terms with the user's geographic search parameters and search terms may be determined according to any desired method. For example, an exact match between the advertiser's zip code and the user's zip code is a sufficient correspondence, in accordance with one embodiment. In another embodiment of the present invention, the user's search may return listings of advertisers whose geographic location is within a predetermined radius of the user's location. In another embodiment of the present invention, a filter or sort process is included such that the search result includes advertisers who are targeting search terms related to the user's entered search term. Lists or tables of related terms may be predetermined and accessible by the search engine server.

In another embodiment of the present invention, advertisers create advertising campaigns to target specific geographic locations. This feature is beneficial in situations where, for example, people in different geographic areas might be interested in different products. For example, a sporting goods store may promote water-sport and beach product specials to users located near beach and lake communities and simultaneously promote non-water related products to users located away from any bodies of water.

When multiple advertisers indicate the same search terms for their listings, bid or payment amounts are used to determine the order in which the listings appear in the search result. An advertisers bid is an agreement to pay for the display of an advertisement in a specified manner and/or under specified circumstances. In one embodiment, the advertiser bids an amount, either predetermined or determined in accordance with certain guidelines and formulas, on each search term or category or industry term the advertiser associates with their default listing or targeted campaigns. The bid amount is a factor in determining the order of listings in a search result, the listing with the higher bid displayed at the top and the remaining listings presented in descending order according to bid amounts. In one embodiment of the invention, the advertiser is charged the bid amount, or has the amount deducted from their deposit account, each time the user selects the advertiser's displayed listing. Notifications are created and sent to advertisers informing them of their ranking order on a particular term. Advertisers may modify their accounts at any time and increase or decrease their bid amounts in order to increase or decrease their bid ranking on the search results for a given search term.

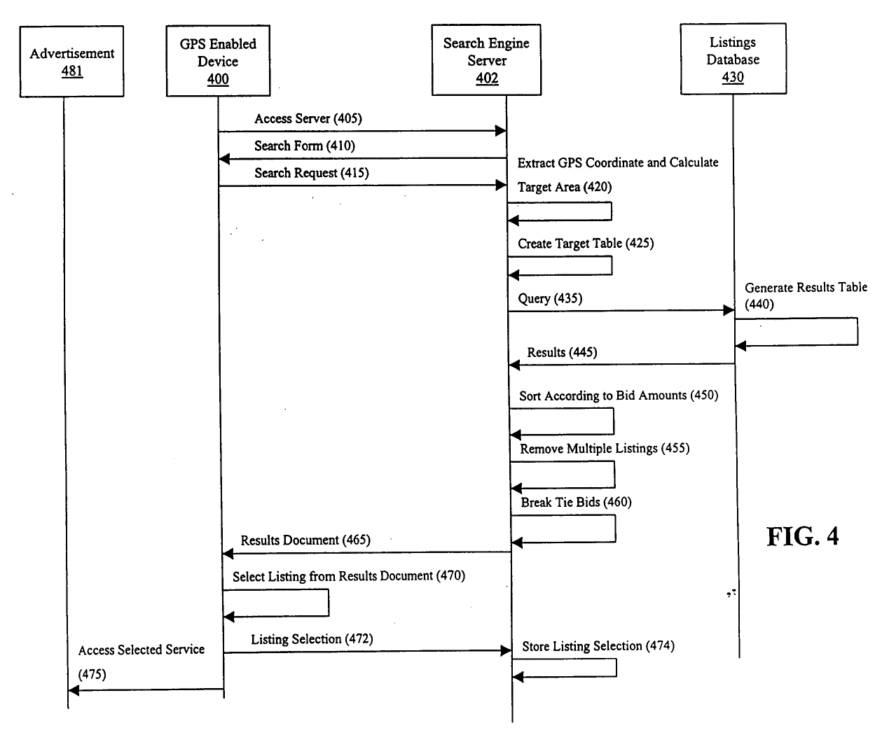

FIG. 4 is a sequence diagram of the process of creating and providing targeted search results in connection with GPS enabled devices, such as a mobile telephone, personal data assistant, laptop or portable computer, auto navigation system, or any other GPS enabled device, in accordance with an embodiment of the present invention. The user accesses the search engine server 402 by directing the GPS enabled device 400 to a site coupled to the server 405. The server 402 sends a search form to the GPS enabled device 410. In another embodiment of the present invention, the server transmits a request for the GPS coordinates which identify the location of the device. The user enters a search term into the search form and transmits the search request to the server 415. In one embodiment of the present invention, the GPS coordinates are automatically transmitted to the server without user interaction. The server 402 extracts the GPS coordinates from the device transmission 420 and creates a target table of all geographic locations within a predetermined proximity of the device's geographic location 425. The target table may be generated directly from the GPS coordinates or, alternatively, the GPS coordinates may be converted into another geographic identifier, such as a zip code or city and state name, with the target table generated using the alternative geographic identifier. The proximity may be expanded and reduced in order to control the number listings returned from a database query. The listing database 430 is queried with the target table and the search terms 435 to generate a results table of all listings that satisfy the database query 440. The search engine server queries the listings database 430 using any desired number of fields, using a database query language or other information retrieval method. The listings database 430 sends the results table to the server 445. Similar to the process described with reference to FIG. 3, the results table is sorted according to bid amount 450, multiple listing by the same advertiser may be removed 455, and tie bids may be ordered 460. After any desired operations are performed on the results table, a result document is sent from the server to the device 465. The user may select a listing from the results document 470. The listing selection is transmitted to the search engine server 472. The search engine server stores the listing selection 474 by, for example, updating a selection record using the listing selection. The device will then access the selected service 480 or information site associated with the listing 475.

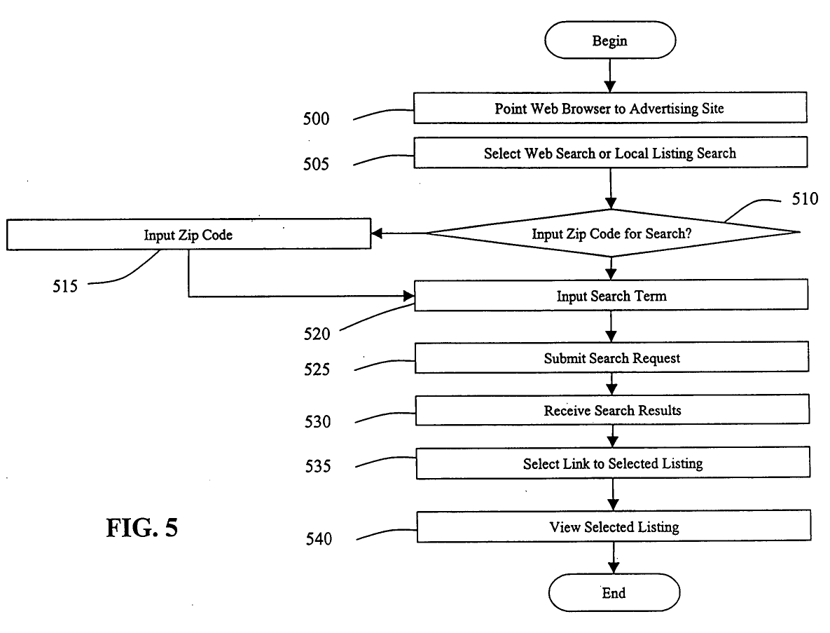

FIG. 5 is a process flow diagram of the steps a user takes to perform a targeted search in accordance with an embodiment of the present invention. The user points a Web browser to the Web site embodying the targeted search engine 500. The Web site is preferably hosted by search engine server but may be hosted by another host, if desired. In one embodiment, the user selects to search Web listings or local listings 505. A choice between Web listings and local area listings is advantageous to both the user and advertisers. For example, if the user is interested in a nationwide retailer or a retailer that provides delivery service to a large number of locations around the country or the world, a user would not benefit from searching local listings only. Similarly, if the user is interested in a local retailer with which the user may interact directly, the user would not want to search the Web for retailers that are not proximate to the user's geographic area. Furthermore, a local advertiser would not be forced to incur costs for bidding on a particular search term searched in the Web if they are interested only in local consumers. In another embodiment, the user searches only Web listings. In yet another embodiment, the user searches only local listings. The user has a choice to input their home zip code if they wish to receive search results having listing that target the user's geographic area 510. If desired, the user enters their home zip code 515 in addition to entering the search term or terms they want to submit 520. The user submits the search request that is transmitted to the search engine server over the Internet 525. The user receives the search results 530 generated by the search engine server in response to the submitted search request. In one embodiment, the user selects a link from the search results 535 and views the selected listing 540.

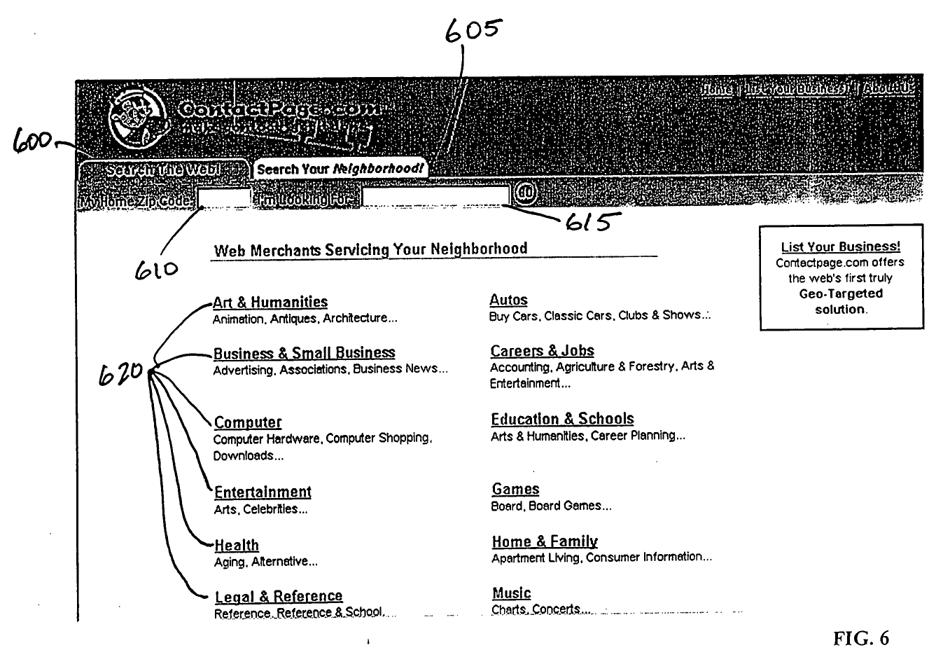

FIG. 6 is a Web page showing a user search form in accordance with an embodiment of the present invention. In one embodiment, the user selects between a search the Web tab 600 and a search locally tab 605 to focus the search to either Web targeted or locally targeted listings. The user inputs their home zip code in a “My Home Zip Code” field 610. By changing the home zip code field, the user searches listings directed to any desired geographic area, including their own local geographic area. In one embodiment, the name of a city and/or state, longitude and latitude coordinates, or any other geographic identifier may be used receive targeted listings. The user inputs one or more search terms in an “I'm Looking For” search term field 615. Category quick links 620 allow the user to view listings and subcategories by selecting one of the category quick links.

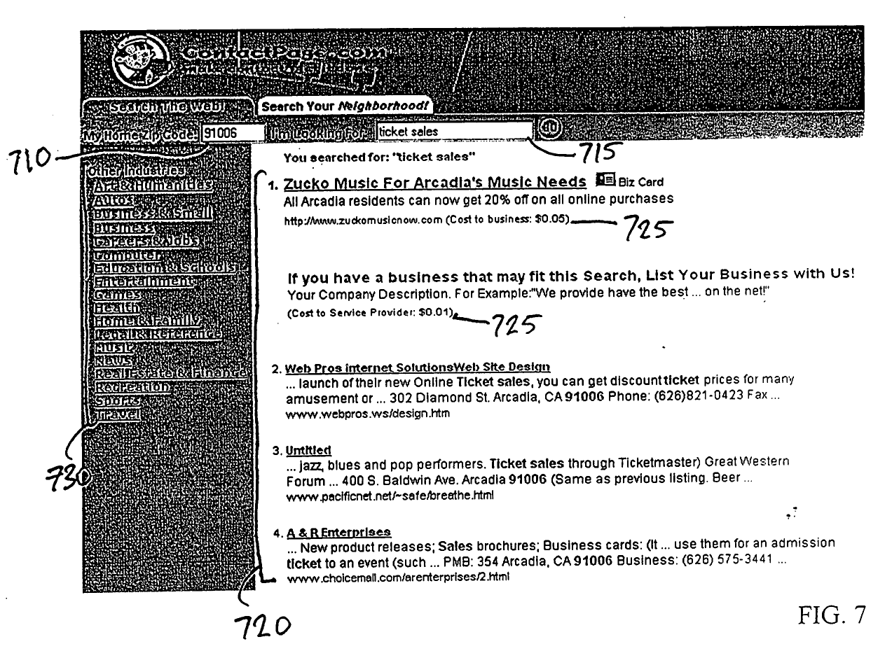

FIG. 7 is a Web page showing a search result in accordance with an embodiment of the present invention. In one embodiment, the search result page shows the zip code targeted, if any, in the “My Home Zip Code” field 710, and the terms searched in the “I'm Looking For” search term field 715. The search result listings 720 are presented in the central portion of the Web page. For illustration purposes, the bid amount the advertiser is paying 725 to display the particular listing resulting from a search of these particular terms shows the hierarchical listing placement on a result page based on bid amount. If the number of listings returned in the search result may not be viewed on the page simultaneously, a link is provided to view the next set of search result listings. In another embodiment, category quick links 730 may also be included in a search result page to allow the quick access to other listings.

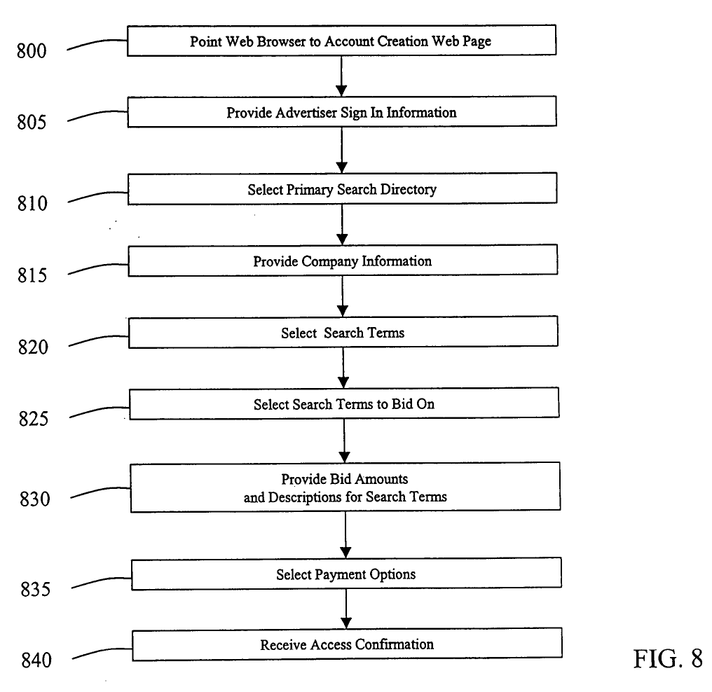

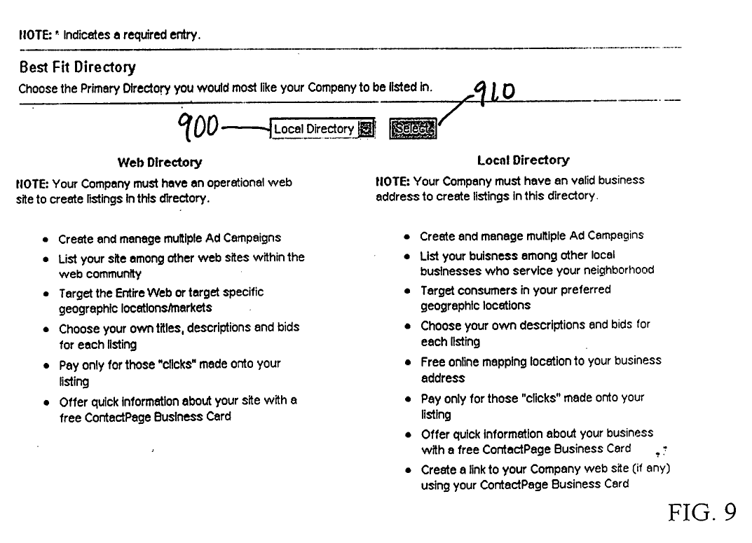

FIG. 8 is a process flow diagram of the steps an advertiser performs to create an account with the targeting search engine in accordance with an embodiment of the present invention. The advertiser points a Web browser to an advertising account creation Web page 800. The advertiser provides any necessary account creation information 805, such as a selected user name, password, title of the person performing the entry, and the name and email address of the person performing the account creation process. The advertiser selects the directory that best fits the advertiser's goods or services 810. In one embodiment, if the advertiser has a operational Web site, the user selects to be listed in the Web directory. In another embodiment, if the advertiser has a business address, the user selects to be listed in the local directory. In another embodiment, the advertiser's listings are accessible by targeted searches regardless of the directory that the user selects. The user also provides additional company information 815, such as the industry that the company is to be listed under, the name of the company, the company Web site, the company phone number, and the company address. The advertiser selects search terms and/or search category words that are to be associated with the advertiser's listings 820. In one embodiment, the advertiser enters a default description that appears with the listing when any of the selected search terms are displayed in response to a user search request. The advertiser selects search terms that it wishes to bid on for display using the targeted search engine 825. Individualized bid amounts and listing descriptions may be specified for each of the selected search terms 830. After submitting the bid amounts and listing descriptions, the advertiser selects a payment option 835 to pay for any expenses incurred due to user search requests. In one embodiment, payment is made using a credit card account number. In another embodiment, the user specifies a payment amount which is not exceeded during operation of the search engine. When the payment amount has been depleted, the administrative server sends an automatically generated notification to the advertiser via email or any other notification system, informing the advertiser that the payment amount has been depleted. Upon completion of the payment selection, the advertiser receives an account creation confirmation 840 including advertiser information, such as user name, an assigned account identification number, indication of the selected payment plan, the payment amount, the date of creation, and any other desired information.

FIG. 9 is a Web page showing a search directory selection form in accordance with an embodiment of the present invention. The advertiser selects the desired primary directory from the “Best Fit Directory” pull-down menu 900. Upon selection, the user submits the selection by selecting a select button 910.

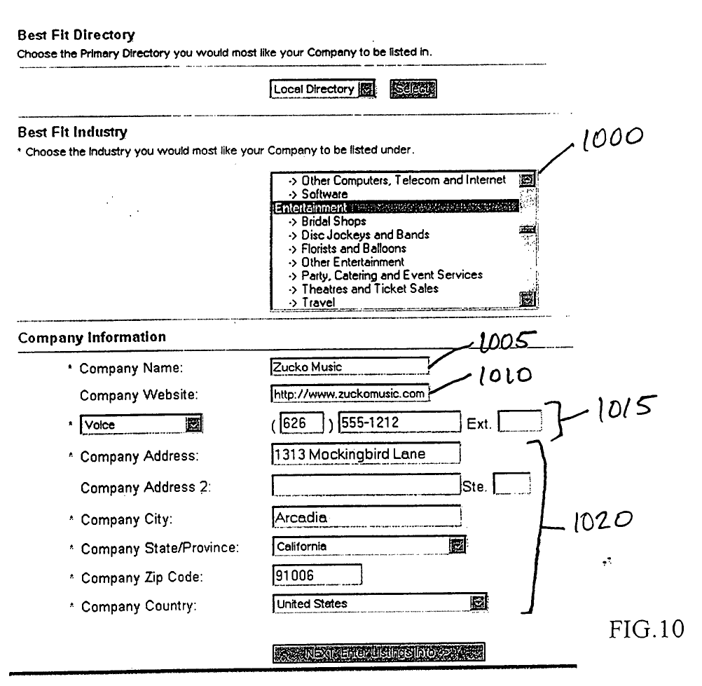

FIG. 10 is a Web page showing a company information entry form in accordance with an embodiment of the present invention. The advertiser selects an industry for their company to be listed under from a “Best Fit Industry” scroll menu 1000. The advertiser further enters additional company information in a “Company Name” field 1005, “Company Web site” field 1010, “Contact Number” field 1015, and company address fields 1020.

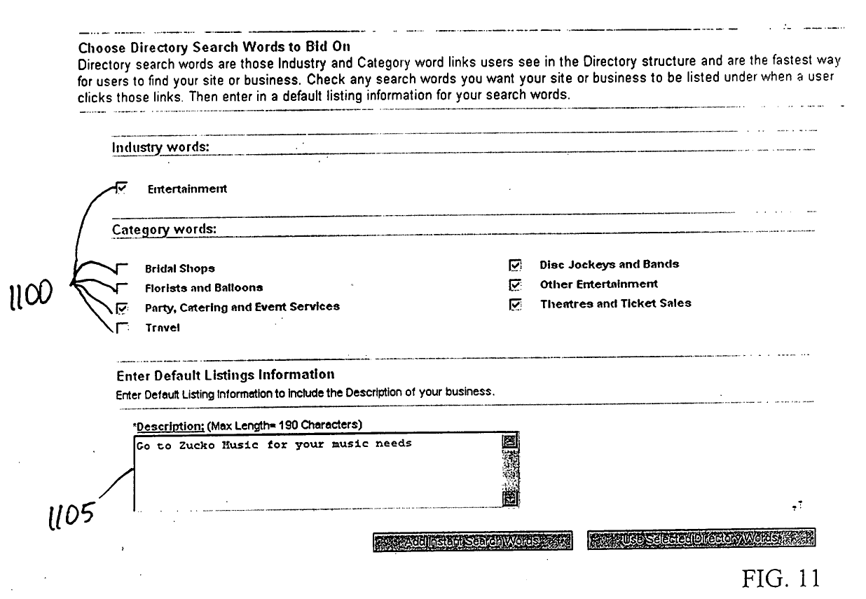

FIG. 11 is a Web page showing a default search information entry form in accordance with an embodiment of the present invention. The advertiser selects terms using select boxes 1100. Default listing information provided in a “Description” text entry field 1105. In one embodiment, the advertiser provides descriptions and bid amounts to be associated with the selected terms.

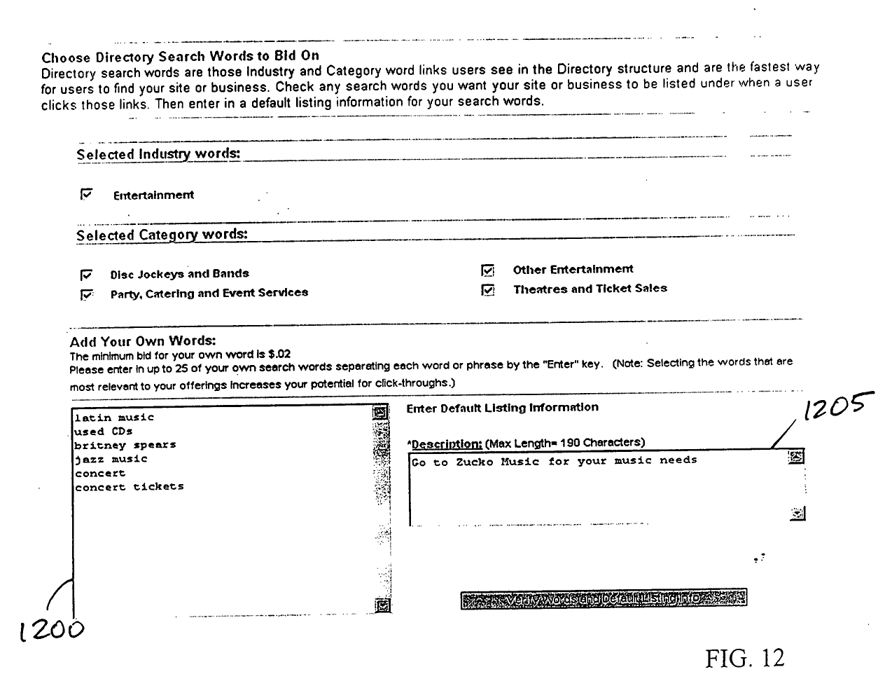

FIG. 12 is a Web page showing a search term creation form in accordance with an embodiment of the present invention. In one embodiment, the advertiser creates specific instant or custom search terms to be associated with the advertiser by entering search terms in text entry field 1200, in addition to predetermined industry and category terms. A default listing description for the created search terms is created in a “Description” text entry field 1205.

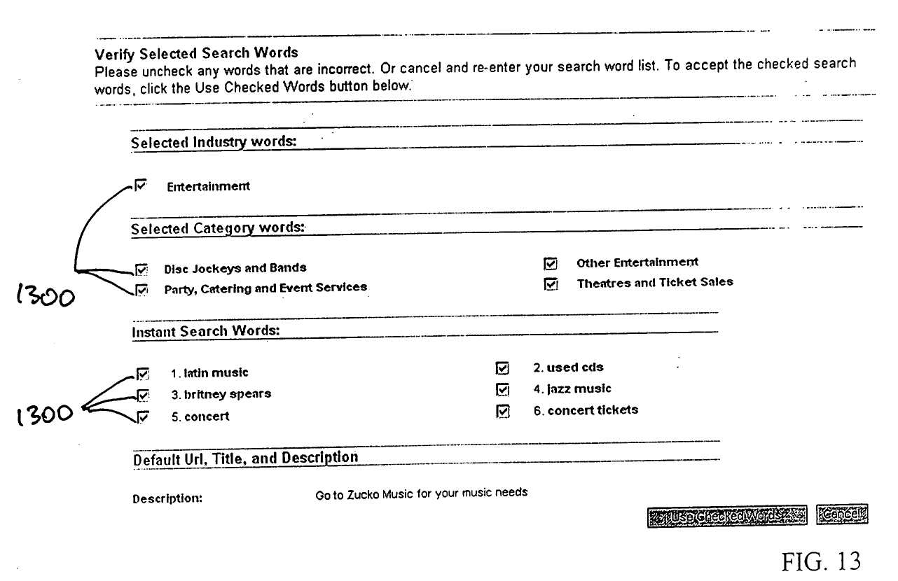

FIG. 13 is a Web page showing a search term selection form in accordance with an embodiment of the present invention. The advertiser selects terms that it wants to be associated with a bid amount and an individualized description. The advertiser identifies terms by using select boxes 1300. In one embodiment, any desired number terms are selected and any combination of industry words, category words, and instant words are selected.

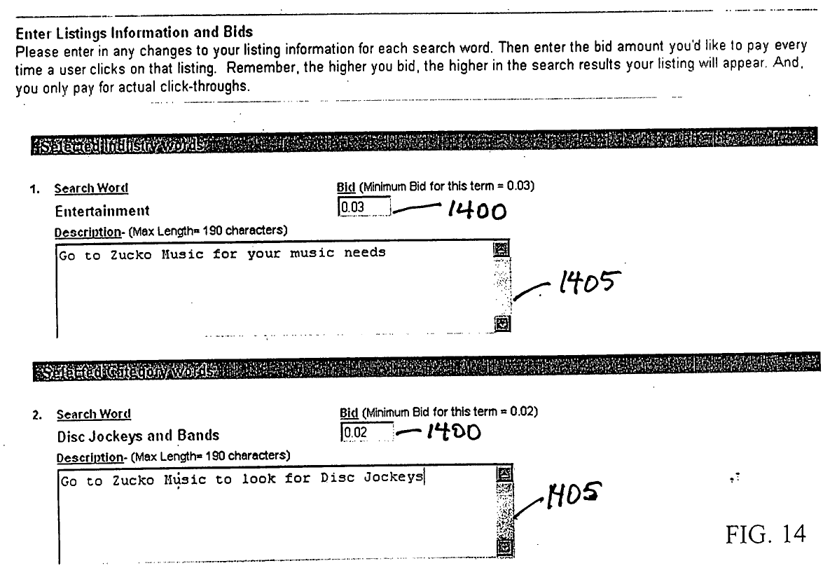

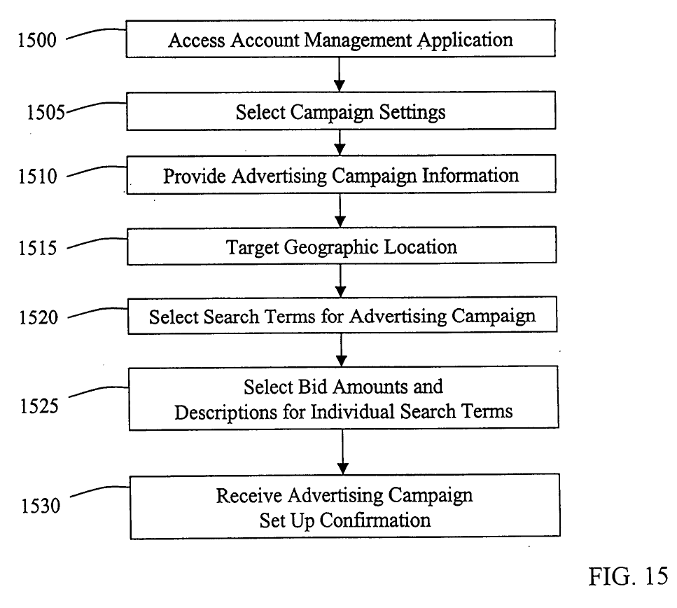

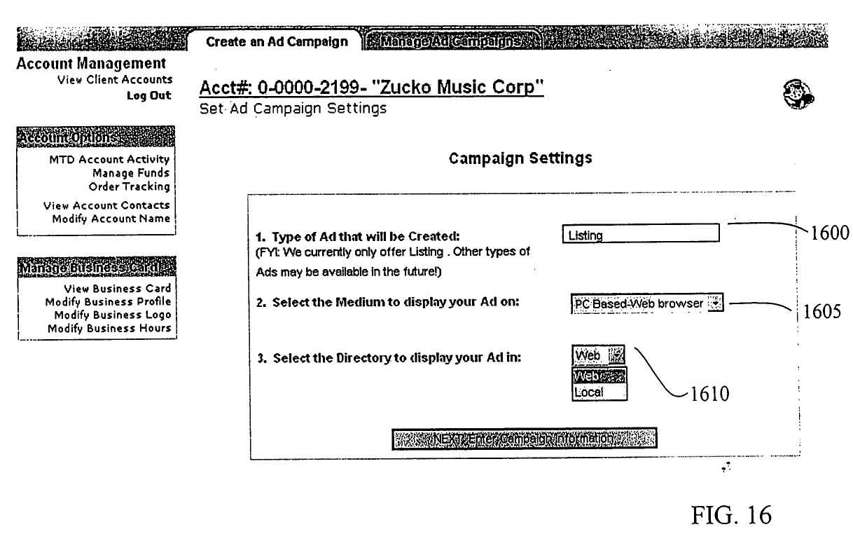

FIG. 14 is a Web page showing a search term individualization and bid specification form in accordance with an embodiment of the present invention. For each search term selected by the advertiser, the advertiser specifies the bid amount for the search term in the “Bid” field 1400 and creates a listing description in the “Description” field 1405 to be associated with each particular search term. Individualized descriptions allow the advertiser create a listing that is likely to appeal to a user searching for that particular term.

FIG. 15 is process flow diagram of the steps an advertiser performs to create a targeted advertising campaign in accordance with an embodiment of the present invention. The advertiser accesses the account management application 1500. In one embodiment, a logon screen requires entry of the advertiser's username, account number, and/or password to authenticate the advertisers authority to access the account management application for use in connection with a particular account. Upon choosing to create a new advertising campaign, the advertiser selects campaign settings for the new campaign 1505. The advertiser selects a medium to display the advertisement from a pull-down menu including, but not limited to, a PC-based Web browser, a wireless device, a GPS enabled device, interactive television (iTV), such as TIVO, WebTV, or DirectTV, or any other suitable advertising medium. In another embodiment, the advertiser also selects a directory to display the advertisement, either the Web directory, the local listing directory, or any other available directory, from a pull-down menu. The advertisement includes any number and any combination of a URL, local listing information, a graphic, such as a banner add and/or Flash animation, audio files, video files, and any other communication medium. Campaign information is provided for the particular campaign 1510, including, but not limited to, a name for the campaign, a description of the campaign, a maximum amount that may be spent on the campaign, and a campaign start and end date. In one embodiment, the advertiser targets specific geographic locations 1515 at any desired level of specificity. For example, the advertiser may choose to target a particular country, a state, a city, a postal zip code, or other location identifier. Search terms are selected or created for the campaign 1520. Any number of terms may be selected and used for a given campaign. A bid amount, URL, title, and/or description may be specified for each of the selected search terms 1525. After the targeted campaign is created, the advertiser will receive a confirmation page confirming the creation of the campaign 1530.

FIG. 16 is a Web page showing a campaign setting selection form in accordance with an embodiment of the present invention. The advertiser selects the campaign settings for the campaign, the settings including the type of listing from the “Type of Ad” field 1600, the medium from the “Medium” field 1605, and the directory in which to display the advertisement from the “Directory” field 1610. The medium is selected from a pull-down menu including, but not limited to, a PC-based Web browser, a wireless device, a GPS enabled device, interactive television (iTV), or any other suitable advertising medium. The directory is selected from a pull-down menu including, but not limited to, Web directory and local listing directory.

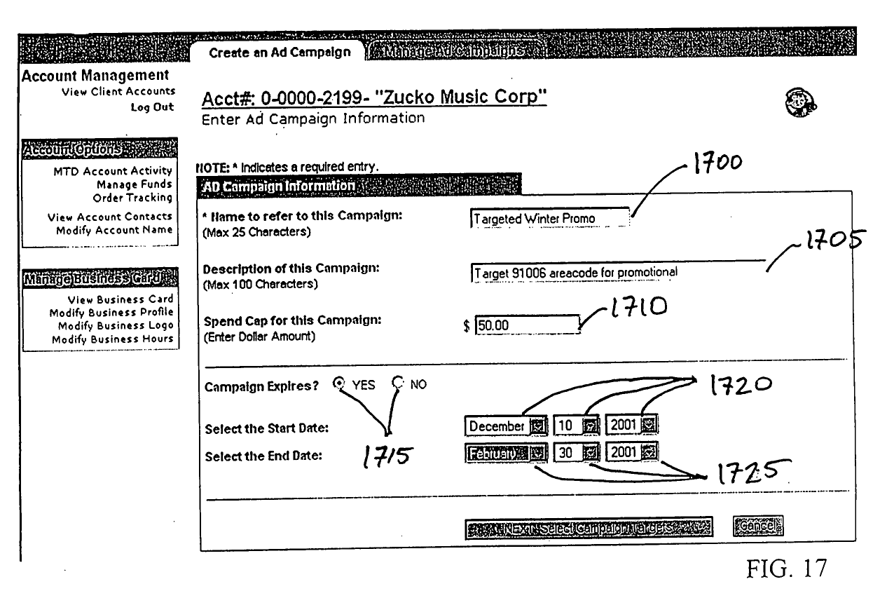

FIG. 17 is a Web page showing a campaign information entry form in accordance with an embodiment of the present invention. Campaign information is provided for the particular campaign by entering a name for the campaign in the “Name” field 1700, a description of the campaign in the “Description” field 1705, the maximum dollar amount to be spent on the campaign in the “Spend Cap” field 1710, and a selection of whether the campaign should expire after a given amount of time from “Campaign Expires” selection boxes 1715. In one embodiment, the advertiser selects a campaign start date and end date from the “Start Date” pull-down menus 1720 and “End Date” pull-down menus 1725.

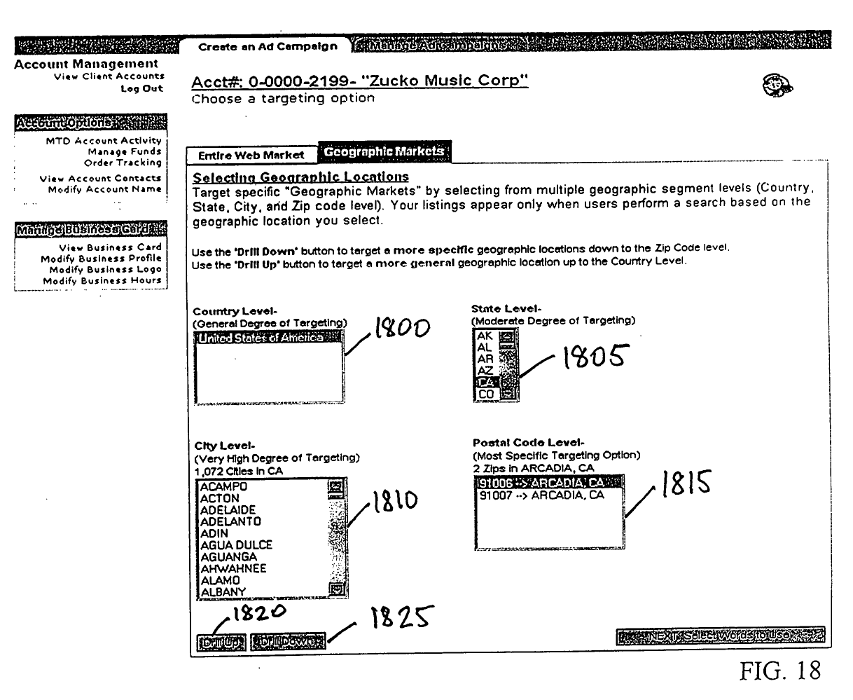

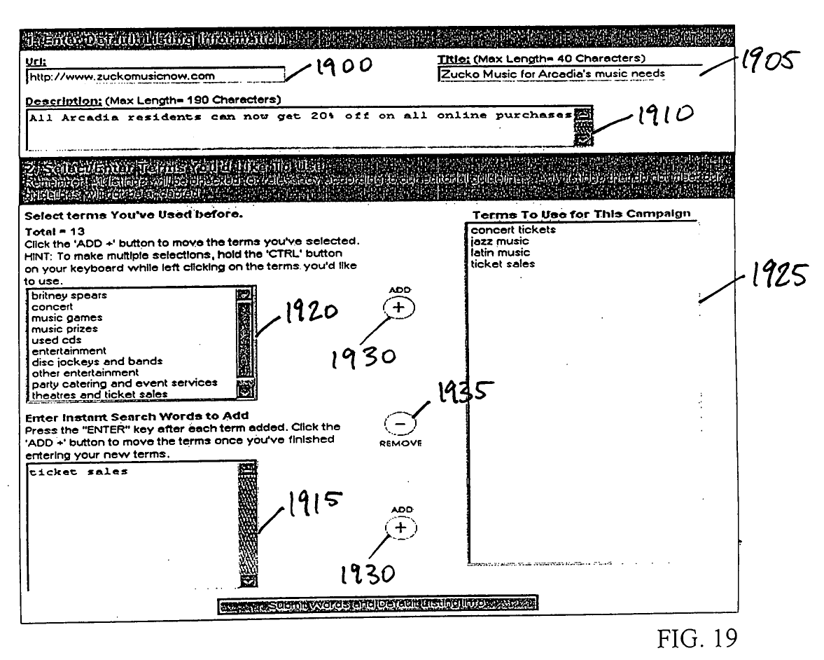

FIG. 18 is a Web page showing a geographic targeting selection form in accordance with an embodiment of the present invention. The advertiser selects geographic areas from a plurality of menus to target specific geographic locations at any desired level of specificity. A country is selected from a “Country Level” menu 1800. The advertiser further selects a state from the “State Level” menu 1805, a city in the selected state from the “City Level” menu 1810, and a postal zip code for the selected city from the “Postal Code Level” field 1815. At any selection level, the advertiser selects “Drill Up” 1820 and “Drill Down” 1825 buttons to decrease or increase the specificity of the geographic area, respectively. Other geographic identifiers may be used to target specific locations and in any desired combination. For example, in another embodiment the nine digit postal code is used instead of the five digit postal code in order to target even more specific geographic areas. In yet another embodiment, telephone area codes are used for geographic targeting.

FIG. 19 is a Web page showing a campaign term selection form in an embodiment of the present invention. The advertiser enters listing information by providing a URL for the advertisers Web site in the “URL” field 1900, the title of the campaign in the “Title” field 1905, and a description of the campaign in the “Description” field 1910. New search terms are entered into the “Instant Search Words” text field 1915. Search terms for use in the campaign are selected from the “Used Before” menu 1920 and the “Instant Search Words” field 1915. The selected search terms are added to the “Terms to Use” field 1925 by selecting the “Add” buttons 1930 and removed from the “Terms to Use” field 1925 by selecting terms and selecting the “Remove” button 1935.

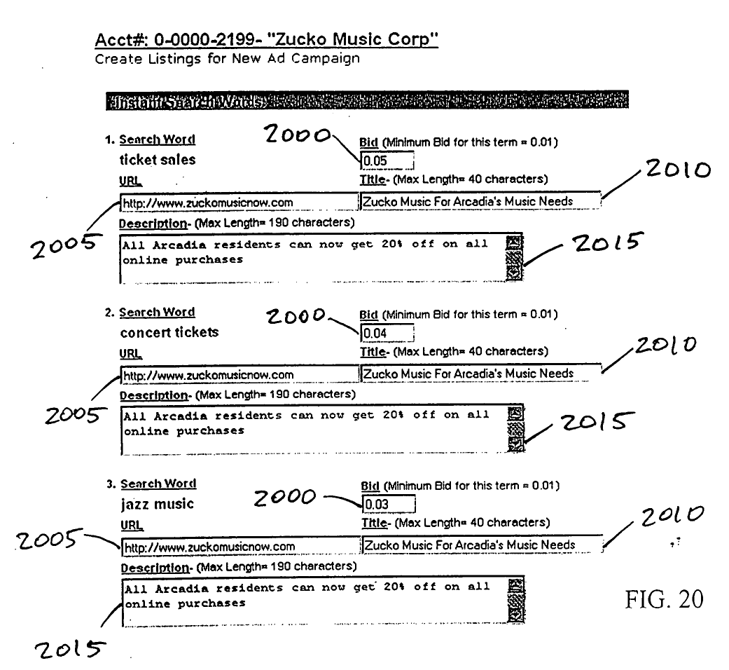

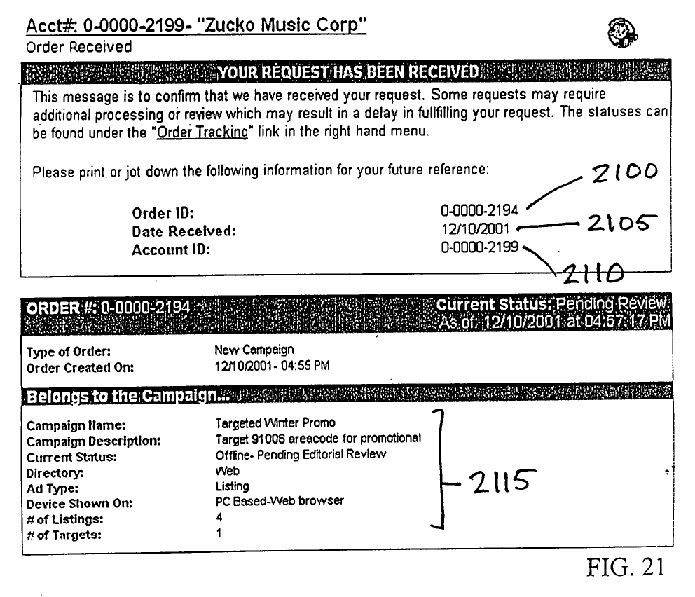

FIG. 20 is a Web page showing a campaign term individualization and bid specification form in accordance with an embodiment of the present invention. The search term individualization for a targeted campaign is similar to the procedure described with reference to FIG. 14. For each search term selected by the advertiser, the advertiser specifies the bid amount for the search term in the “Bid” field 2000, specifies the URL in the “URL” field 2005, creates a title in the “Title” field 2010, and provides a description of the campaign in the “Description” field 2015. Accordingly, each search term, if desired, may be associated with a different bid amount, URL, title, and description. Individualized, targeted bids, URLs, titles, and descriptions allow the advertiser create precisely targeted listings that are likely to appeal to a user searching for that particular term.

FIG. 21 is a Web page showing a campaign confirmation form in accordance with an embodiment of the present invention. Upon completion of the campaign creation, the advertiser receives a confirmation form including, but not limited to, an order identification number 2100, a date the campaign was created and received by the administrator 2105, and the account identification number of the advertiser 2110. In another embodiment, the confirmation also contains information about the campaign that was created and submitted 2115, including, but not limited to, the status, name, description, directory, ad type, device selection, number of listings, and number of targets for the created advertising campaign.

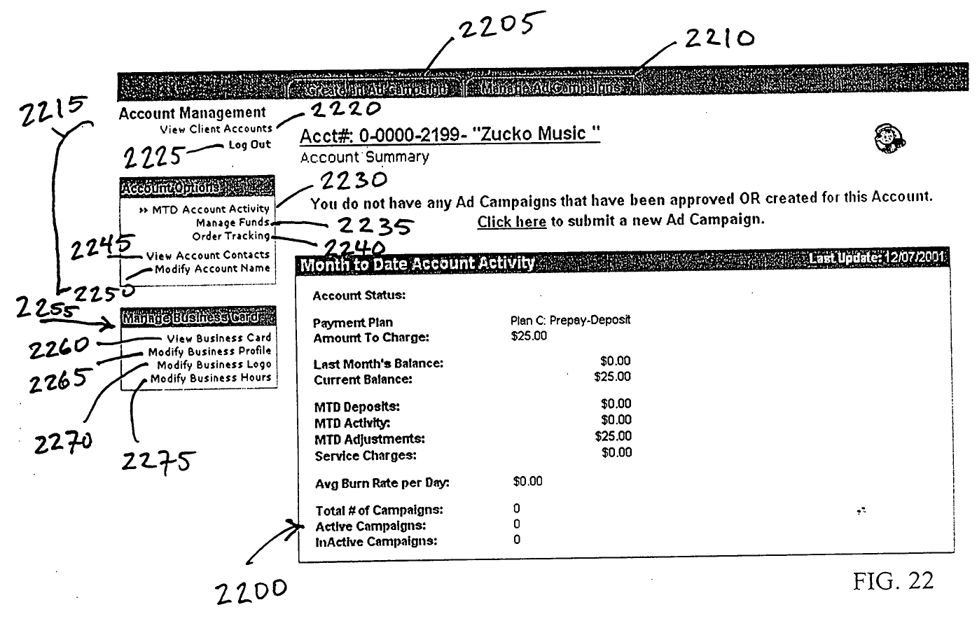

FIG. 22 is a Web page showing an advertiser management page in accordance with an embodiment of the present invention. The advertiser has access to a plurality of tools for use in managing, modifying, and customizing advertising campaigns and account information. On the Web page in one embodiment of the present invention, a summary of account information and account activity 2200 is provided. From the advertiser management page, the advertiser selects a “Create an Ad” tab 2205 to create new advertising campaigns or a “Manage Ad” tab 2210 to manage previously created advertising campaigns. From an options menu 2215, the advertiser selects from links to tools and viewing options including, but not limited to, a “View Client Accounts” link 2220, a “Log Out” link 2225, a “Month to Date” account activity link 2230, a “Manage Funds” link 2235, an “Order Tracking” link 2240, a “View Account Contacts” link 2245, and a “Modify Account Name” link 2250. From a “Manage Business Card” menu, the advertiser selects links including, but not limited to, a “View Business Card” link 2260, a “Modify Business Profile” link 2265, a “Modify Business Logo” link 2270, and a “Modify Business Hours” link. The manage business card options allow the advertiser to change the advertiser's information and the appearance of the advertiser's listings that are presented to the user.

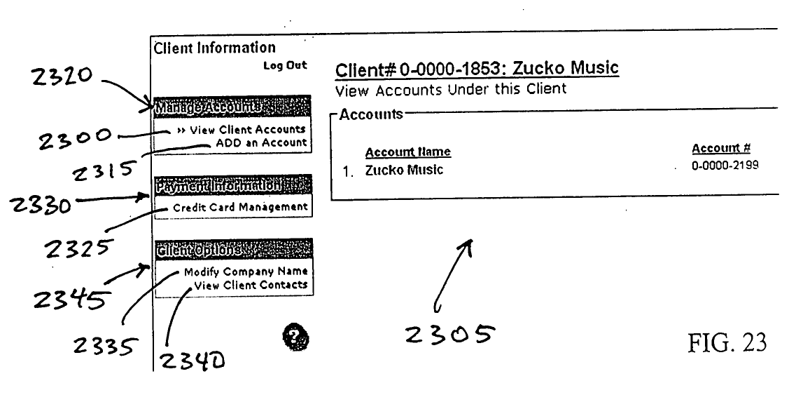

FIG. 23 is a Web page showing an advertiser account management page in accordance with an embodiment of the present invention. In the illustrated embodiment, the advertiser has chosen to view all of the accounts by selecting the “View Client Accounts” link 2300. All the accounts for the particular advertiser are shown in the account display area 2305 of the page. In the illustration shown, one account is shown in the account display area 2305 of the page. In one embodiment, the advertiser selects a “View Client Accounts” link 2300 and a “Add an Account” link 2315 from the “Manage Accounts” menu 2320, a “Credit Card Management” link 2325 from the “Payment Information” menu 2330, and a “Modify Company Name” link 2335 and a “View Client Contacts” link 2340 from the “Client Options” menu 2345.

In one embodiment of the invention, a quick bid feature allows the advertiser to update the performance criteria, such as the bid amount or the placement indication, without necessarily accessing the account management system. A Web page displays a quick bid link when the search engine in used by the advertiser. A cookie or other identifier may be used to indicate to the search engine that the user is a participating advertiser or a non-advertiser. The advertiser selects the quick bid link to modify the bid amount or placement indication. A login screen is provided to verify the identity of the advertiser. For example, an advertiser may perform a search using the targeted search engine to verify the placement of their advertisement in the search result. From the search result, the advertiser may select the quick bid link to change the bid and rank directly from the search result, or another Web page.

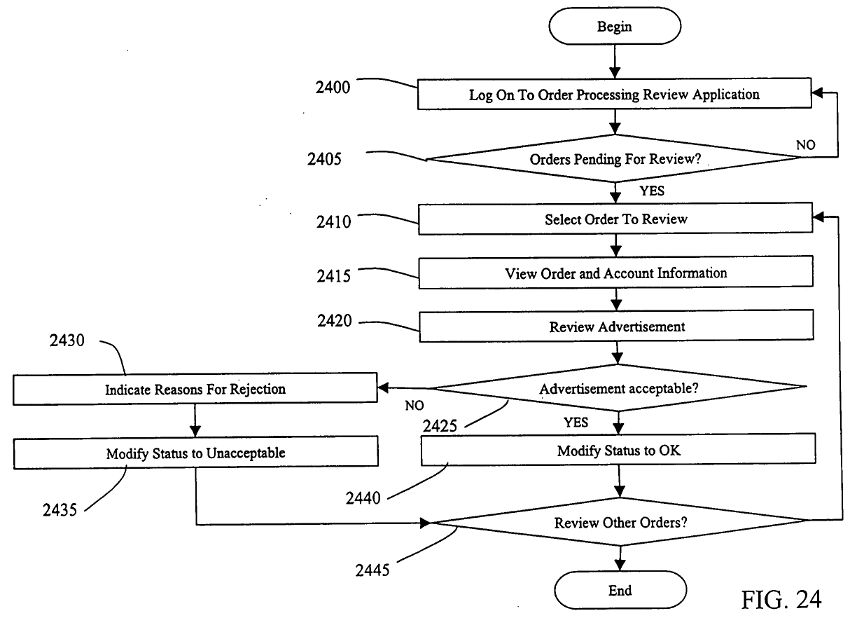

FIG. 24 is a process flow diagram of the steps a search engine server administrator performs to review advertiser sign ups and campaign creations in accordance with an embodiment of the present invention. The site administrator accesses the order processing review application 2400 to review orders submitted by the advertiser. In one embodiment, orders include new accounts created by new advertisers, new advertising campaigns submitted by advertisers with existing accounts, requests for modifications to advertising campaigns, modifications to account information, and/or any other activities by advertisers which require review. The administrator determines if orders are pending for review 2405. If there are no orders pending, the administrator exits the review application or wait for orders to be submitted for review. Otherwise, the administrator selects an order to review 2410. The administrator reviews order information and account information for the order 2415. The administrator selects to review the advertisement or modification request that has been submitted by the advertiser 2420. During review of the advertisement or modification request, the administrator reviews the title, the description, the URL, or other information. In one embodiment, the administrator may also input comments regarding the advertisement or modification request. After determining whether the submitted advertisement or modification request is acceptable or unacceptable 2425, the administrator indicates reasons for rejection 2430, if necessary, in a comments field and modifies the status of the advertisement or modification request to “Unacceptable” 2435, or modifies the status of the advertisement or modification request to “OK” 2440. If there are other orders to review, the administrator may select the next order to review 2445, exit the review application or wait for orders to be submitted for review.

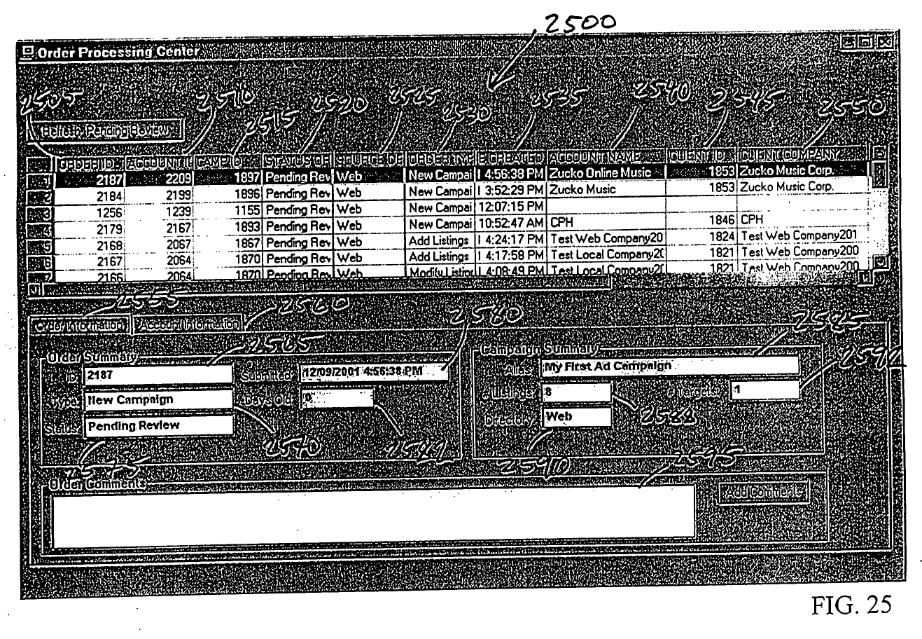

FIG. 25 is a screen shot of a search engine order management system in accordance with an embodiment of the present invention. A table 2500 displays a plurality of orders, each row containing information on the submitted order in column fields. In the illustrated screen shot, the table includes column fields for, but not limited to, the order identification number 2505, account identification number 2510, campaign identification number 2515, status of the order 2520, the source of the order 2525, descriptions of the type of order 2530, such as, for example, whether the order is a new campaign, an new listing, or a modification of a listing, the date and time the order was created 2535, the account name 2540, the client identification number 2545, and the name of the client company 2550. The administrator may select the “Order Information” tab 2555 and the “Account Information” tab 2560 to view the order information and account information, respectively. In the illustrated screen shot, order information is shown having information in an “Order ID” field 2565, a “Type” field 2570, a “Status” field 2575, a “Submitted” field having the date and time of submission 2580, a “Days Old” field 2582, an “Alias” field 2585, a “Number of Listings” field 2588, a “Number of Targets” field 2590, and a “Directory” field 2592. In one embodiment, the administrator adds comments to the order in the “Order Comments” text entry field 2595.

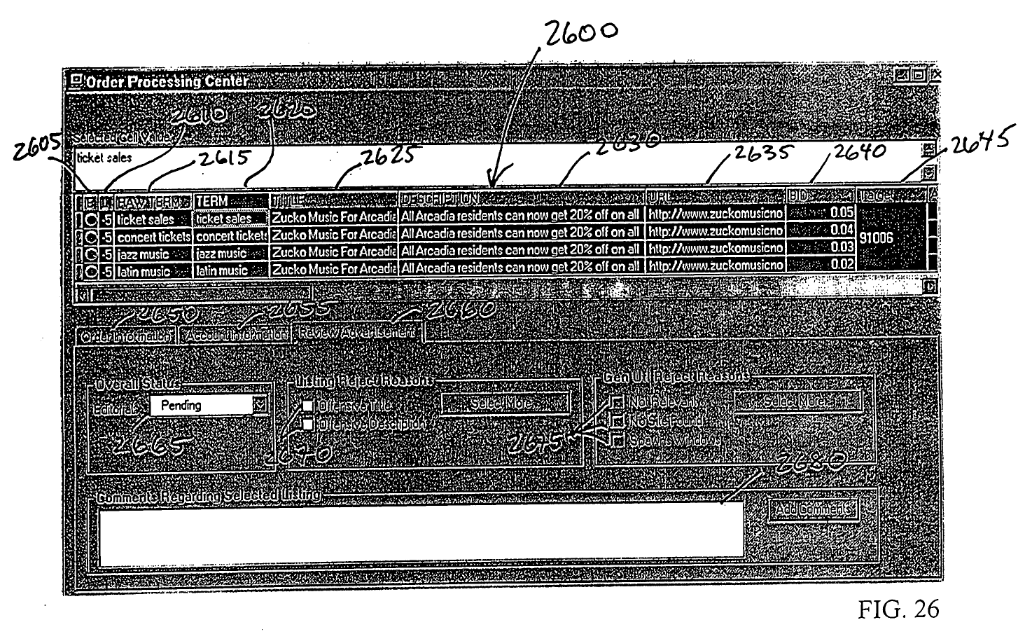

FIG. 26 is a screen shot of a search engine advertisement review system in accordance with an embodiment of the present invention. A table 2600 displays a plurality of advertisements, each row having information on a separate search term, the table having information for each search term in column fields. In the illustrated screen shot, the table includes column fields for, but not limited to, miscellaneous system criteria fields 2605 and 2610, raw term 2615, term 2620, title 2625, description 2630, URL 2635, bid amount 2640, and the targeted area 2645. The administrator may select an “Order Information” tab 2650, an “Account Information” tab 2655, and a “Review Advertisement” tab 2660 to view the order information, account information, and review advertisement tool, respectively. In the illustrated screen shot, the review advertisement tool is shown having an “Editorial State” pull-down menu 2665, from which the administrator may change the status of the advertisement, “Listing Reject Reasons” select boxes 2670, “URL Reject Reasons” select boxes 2675, and a “Comments” text entry field 2680.

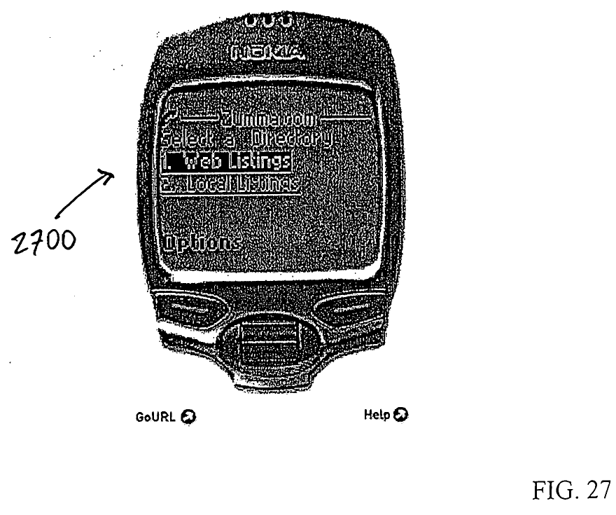

FIG. 27 is a diagram of a search engine user interface for a wireless device 2700 in accordance with an embodiment of the present invention. In the illustrated user interface, the user selects either a Web listings directory or a local listings directory to perform a search. The user operates the wireless telephone in accordance with the telephone manufacturer's specifications. In one embodiment, the wireless telephone receives listings and forms according to the sequence described with reference to FIG. 4.

In one embodiment, the targeted search engine uses a multiple-panel format such that more than one search and or search result may be displayed. A display includes two panels where Web listing search results are displayed in a first panel and local listing search results are displayed in a second panel. Accordingly, one search may generate two separate search results. In another embodiment, multiple panels are used to perform searches in different geographic areas, using different demographic parameters, search terms, or any other search criteria. Any number of panels may be used to display any desired combination of search results.

In another embodiment, the advertiser targets users based on the user's location using GPS technology. A user's location is identified using GPS. The user location can then be used to calculate the user's distance from advertisers or businesses. Advertisements or announcements may be targeted to users based on their proximate location to the advertiser. The user selects an operation mode or category, such as food, shopping, or travel, that is stored on the user's device. In one embodiment, the user's demographic information and geographic information are stored on the user's device, and the search result is broadcast over the licensed or unlicensed electromagnetic airwaves for interception by a wireless receiver that enables such device to display organized, formatted, displayed and sorted search result having advertisements related to the selected operation mode, the user's demographic information, and/or the user's geographic information. In another embodiment, the search result is broadcast at regular and/or periodic intervals, a specified time, or any specified number of times in any given time period. In yet another embodiment, the search result is transmitted to accounts unique to users on a third party computer for storage and later retrieval the user, where the accounts are designed such that they accept only advertisements related to the user's selected operation mode, user's demographic information, and/or the user's geographic information. The search result may be transmitted at selected times over the licensed or unlicensed electromagnetic airwaves for interception by a wireless receiver coupled to the user device that enables the device to display the search result having advertisements related to user's selected operation mode, user's demographic information, and/or the user's geographic information. The search result is transmitted when the user is in a selected area that has been either identified by the advertiser or the user. In another embodiment, the search result may be transmitted without the user search request. The search request may be organized, formatted, displayed, modified, and sorted as desired. The user device may be one or more of a computer, a terminal, a personal data assistant, a mobile telephone, a third party computer, or any other mobile device, or any other devices coupled to a communications network.

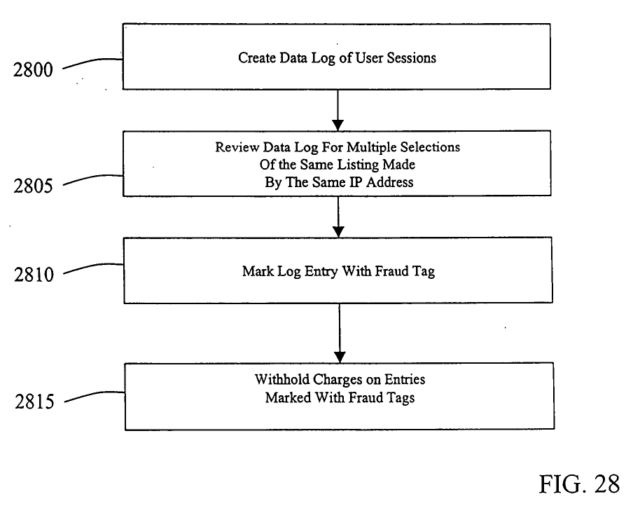

In one embodiment the targeted search engine is provided with fraud detection logic to prevent advertisers from incurring charges as a result of illegitimate searches. For example, competitors may repeatedly search a particular term to force the advertiser bidding highest for that term to incur a burdensome amount of costs. As a result, the advertiser would be forced to cease bidding on the term and lower bidding competitors would have their advertisements listed ahead of the forced out competitor. FIG. 28 is a flow diagram of a search engine log creation and fraud prevention according to an embodiment of the present invention. Data logs are created to record all activities that occur on the search engine. At least one data log is created containing entries for each of the user search requests and user listing selections 2800. The data log contains entries of all account creations, campaign creations, account management operations performed by the advertiser, searches performed by users accessing the targeted search engine, and any other operations associated with the search engine. The data log may further include the format of search results displayed, the number of times a listing was selected, the order in which listings were displayed in the search result, and the bid amounts associated with each listing in the search result. For fraud detection and prevention, the data log is reviewed for listings that have been selected multiple times by one or more users having the same IP address 2805. Multiple selections by users having the same IP address is generally an indication that a user is attempting to accrue a large advertising expense for a particular advertiser. When the IP address participating in potentially fraudulent activity is identified, the log entries with that IP address are tag as fraudulent entries 2810. Charges are withheld on those entries that are marked with fraud tags 2815 so that the advertiser will not be charged for fraudulent searches and listing selections.

Embodiments of the present invention have been presented for use with HTML documents. Those skilled in the art will recognize that any electronic document composed in any markup language may be implemented for use in the targeted search engine. These electronic documents may be displayed on a variety of devices including handheld general purpose computers, personal digital assistants (PDAs), and wireless telephones with access to a digital communications network such as the Internet.

Although this invention has been described in certain specific embodiments, many additional modifications and variations would be apparent to those skilled in the art. For example, the targeted search engine described herein is one that uses geographic limiting parameters; however, many other types of limiting parameters may be used in a targeted search enging. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents.

1. A method for generating a targeted search result comprising:
receiving a search request from a user over a communications network, the search request including a search term and a limiting parameter;
generating a search listing using the search term and the limiting parameter;
generating the search result using the search listing and a performance criterium; and
transmitting the search result to the user.

2. The method of claim 1, wherein the search result is generated by sorting the search listing using the performance criterium.

3. The method of claim 1, wherein the performance criterium is a bidding criterium.

4. The method of claim 1, wherein the performance criterium is a predetermined amount, wherein the predetermined amount is associated with a preferred search result location.

5. The method of claim 1, wherein the limiting parameter is a postal zip code.

6. The method of claim 1, wherein the limiting parameter is a global positioning system signal.

7. The method of claim 1, wherein the limiting parameter is a latitude and longitude coordinate.

8. The method of claim 1, wherein the limiting parameter is an area code.

9. The method of claim 1, wherein the limiting parameter is a telephone number.

10. The method of claim 1, further comprising:
sorting the search listing using a second performance criterium, wherein the second performance criterium is an advertiser importance value.

11. The method of claim 1, further comprising providing a database having a plurality of advertisements, wherein each of the plurality of advertisements includes a preferential placement indication; and wherein sorting the search listing includes placing the one or more of the plurality of advertisements in a preferred position in the search result.

12. The method of claim 1, further comprising providing a database having a plurality of advertisements, wherein each of the plurality of advertisements includes an advertisement search parameter and a geographic targeting parameter; and
generating a search listing further includes:
generating a relevance measure for each of the advertisements by comparing the search term to each of the advertisement search parameters;
generating a geographic measure for each of the advertisements by comparing the limiting parameter to each of the geographic targeting parameters; and
retrieving advertisements from the database using each of the relevance measures and each of the geographic measures.

13. The method of claim 2, wherein the search result includes one or more selectable listings, the method further comprising:
receiving a listing selection from the user;
updating a selection record using the listing selection; and
charging an advertiser account using the selection record.

14. The method of claim 1, further comprising:
providing a database having a plurality of advertisements, wherein the plurality of advertisements are stored in the database in a table, the table including a network location field; and
generating the search result includes selecting the network location field from the table.

15. The method of claim 1, further comprising providing a database having a plurality of advertisements, wherein each of the plurality of advertisements includes an advertisement search parameter, a geographic targeting parameter, and a performance parameter.

16. The method of claim 15, wherein the performance parameter is a bid amount associated with the advertisement search parameter.

17. The method of claim 15, wherein each of the plurality of advertisements further includes a display format parameter and a display platform parameter.

18. The method of claim 1, wherein generating a search listing further includes generating a second search listing, the method further comprising transmitting a second search result, wherein the second search result is generated using the second search listing.

19. The method of claim 18, wherein the search result is displayed in a first panel, and the second search result is displayed in a second panel.

20. The method of claim 19, wherein the search result is a Web search result and the second search result is a local search result.

21. A method for generating a targeted search result comprising:
receiving a search request from a user over a communications network, the search request
including a search term and a limiting parameter;
generating a demographic parameter using the limiting parameter;
generating a search listing using the search term and the demographic parameter;
sorting the search listing using a performance criterium;
generating a search result using the sorted search listing; and
transmitting the search result to the user.

22. The method of claim 21, wherein the performance criterium is a bidding criterium.

23. The method of claim 21, wherein the limiting parameter is a postal zip code.

24. The method of claim 21, wherein the limiting parameter is a global positioning system signal.

25. The method of claim 21, wherein the limiting parameter is a latitude and longitude coordinate.

26. The method of claim 21, wherein the limiting parameter is an area code.

27. The method of claim 21, wherein the limiting parameter is a telephone number.

28. The method of claim 21, further comprising:
sorting the search listing using a second performance criterium, wherein the second performance criterium is an advertiser importance value.

29. The method of claim 21, further comprising:
providing a database having a plurality of advertisements, wherein each of the plurality of advertisements includes a preferential placement indication; and
sorting the search listing includes placing the one or more of the plurality of advertisements in a preferred position in the search result.

30. The method of claim 21, further comprising providing a database having a plurality of advertisements, wherein each of the plurality of advertisements includes an advertisement search parameter, a geographic targeting parameter, and a demographic targeting parameter; and
generating a search listing further includes:
generating a relevance measure for each of the advertisements by comparing the search term to each of the advertisement search parameters;
generating a geographic measure for each of the advertisements by comparing the limiting parameter to each of the geographic targeting parameters;
generating a demographic measure for each of the advertisements by comparing the demographic parameter to each of the demographic targeting parameters; and
retrieving advertisements from the database using each of the relevance measures, each of the geographic measures, and each of the demographic measures.

31. The method of claim 22, wherein the search result includes one or more selectable listings, the method further comprising:
receiving a listing selection from the user;
updating a selection record using the listing selection; and
charging an advertiser account using the selection record.

32. A method for generating a targeted search result comprising:
receiving a search request from a user over a communications network, the search request including a search term, a demographic parameter, and a limiting parameter;
generating a search listing using the search term, the limiting parameter, and the demographic parameter;
sorting the search listing using a performance criterium; and
transmitting a search result to the user, the search result generated using the sorted search listing.

33. The method of claim 32, wherein the performance criterium is a bidding criterium.

34. The method of claim 32, wherein the limiting parameter is a postal zip code.

35. The method of claim 32, wherein the limiting parameter is a global positioning system signal.

36. The method of claim 32, wherein the limiting parameter is a latitude and longitude coordinate.

37. The method of claim 32, wherein the limiting parameter is an area code.

38. The method of claim 32, wherein the limiting parameter is a telephone number.

39. The method of claim 32, wherein the demographic parameter is an ethnicity identification.

40. The method of claim 32, wherein the demographic parameter is socioeconomic classification.

41. The method of claim 32, wherein the demographic parameter is an age group classification.

42. The method of claim 32, wherein the demographic parameter is an income classification.

43. The method of claim 32, further comprising sorting the search listing using a second performance criterium, wherein the second performance criterium is an advertiser importance value.

44. The method of claim 32, further comprising:
providing a database having a plurality of advertisements, wherein each of the plurality of advertisements includes a preferential placement indication; and
sorting the search listing includes placing the one or more of the plurality of advertisements in a preferred position in the search result.

45. The method of claim 32, further comprising providing a database having a plurality of advertisements, wherein each of the plurality of advertisements includes an advertisement search parameter and a geographic targeting parameter; and
generating a search listing further includes:
generating a relevance measure for each of the advertisements by comparing the search term to each of the advertisement search parameters;
generating a geographic measure for each of the advertisements by comparing the limiting parameter to each of the geographic targeting parameters; and
retrieving advertisements from the database using each of the relevance measures and each of the geographic measures.

46. The method of claim 32, further comprising:
receiving a listing selection from the user;
maintaining a selection record including the listing selection; and
charging an advertiser account using the selection record.

47. The method of claim 32, further comprising:
providing a database having a plurality of advertisements, wherein the plurality of advertisements are stored in the database in a table, the table including a network location field; and
generating the search result includes selecting the network location field from the table.

48. A data processing system for generating a targeted search result comprising:
a database including a plurality of advertisements;
a processor; and
a memory operably coupled to the processor and having program instructions stored therein, the processor being operable to execute the program instructions, the program instructions including:
instructions for generating a search listing using a user search term and a limiting parameter;
instructions for sorting the search listing using a performance criterium;
instructions for generating a search result using the sorted search listing; and
instructions for transmitting the search result to the user over a communications network.

49. The system of claim 48, wherein the performance criterium is a bidding criterium.

50. The system of claim 48, wherein the program instructions further include:
instructions for generating a second search listing using the user search term;
instructions for generating a second search result using the second search listing; and
instructions for transmitting a second search result, wherein the second search result is generated using the second search listing.

51. The apparatus of claim 50, wherein the search result is displayed in a first panel, and the second search result is displayed in a second panel.

52. The apparatus of claim 51, wherein the search result is a Web search result and the second search result is a local search result.

53. The system of claim 48, the program instruction further including:
instructions for receiving a listing selection from the user;
instructions for maintaining a selection record including the listing selection; and
instructions for charging an advertiser account using the selection record.

54. An apparatus for generating a targeted search result comprising:
means for receiving a search request from a user over a communications network, the search request including a search term and a limiting parameter;
means for generating a search listing using the search term and the limiting parameter;
means for sorting the search listing using a performance criterium;
means for generating a search result using the sorted search listing; and
means for transmitting the search result to the user, the search result further having one or more selectable listings.

55. The apparatus of claim 54, wherein the performance criterium is a bidding criterium.

56. A method for generating a targeted search result comprising:
receiving a search request from a user over a communications network, the search request including a search term and a demographic parameter;
generating a search listing using the search term and the demographic parameter;
sorting the search listing using a performance criterium; and
transmitting a search result to the user.

57. The method of claim 56, wherein the search result is generated using the sorted search listing.

58. The method of claim 56, wherein the performance criterium is a bidding criterium.

59. The method of claim 56, wherein the demographic parameter is an ethnicity identification.

60. The method of claim 56, wherein the demographic parameter is socioeconomic classification.

61. The method of claim 56, wherein the demographic parameter is an age group classification.

62. The method of claim 56, wherein the demographic parameter is an income classification.

63. The method of claim 56, further comprising providing a database having a plurality of advertisements, wherein each of the plurality of advertisements includes a preferential placement indication; and wherein sorting the search listing includes placing the one or more of the plurality of advertisements in a preferred position in the search result.

64. The method of claim 56, further comprising providing a database having a plurality of advertisements, wherein each of the plurality of advertisements includes an advertisement search parameter and a demographic targeting parameter; and
generating a search listing further includes:
generating a relevance measure for each of the advertisements by comparing the search term to each of the advertisement search parameters;
generating a demographic measure for each of the advertisements by comparing the demographic parameter to each of the demographic targeting parameters; and
retrieving advertisements from the database using each of the relevance measures and each of the demographic measures.

65. The method of claim 56, wherein the search result includes one or more selectable listings, the method further comprising:
receiving a listing selection from the user;
updating a selection record using the listing selection; and
charging an advertiser account using the selection record.

66. The method of claim 56, further comprising:
providing a database having a plurality of advertisements, wherein the plurality of advertisements are stored in the database in a table, the table including a network location field; and
generating the search result includes selecting the network location field from the table.
